(19) United States
(12) Patent Application Publication
(10) Pub. No.: US 2026/0180874 A1
(43) Pub. Date: Jun. 25, 2026

(54) Consumer Participative Machine Learning (ML) Model Training in 5G Core Network

(71) Applicant: Telefonaktiebolaget LM Ericsson (publ), Stockholm (SE)

(72) Inventors: Jing Yue, Danderyd (SE); Zhang Fu, Stockholm (SE)

(21) Appl. No.: 19/125,999

(22) PCT Filed: Nov. 2, 2023
(86) PCT No.: PCT/IB2023/061084

§ 371 Date: Apr. 30, 2025

Related U.S. Application Data
(60) Provisional application No. 63/422,135, filed on Nov. 3, 2022.

(51) Int. Cl. H04L 41/16; H04L 41/14

(52) U.S. Cl. CPC H04L 41/16; H04L 41/145

(57) ABSTRACT

New parameters and procedures are provided by which a server Network Data Analytics Function (NWDAF) (400) having a Model Training Logical Function (MTLF) can select and approve one or more consumer Network Functions (NFs) (500) having an Analytics Logical Function (AnLF) to participate in upcoming and/or ongoing machine learning (ML) model training processes. The ML model training could be, for example, any arbitrary ML format/architecture supported by NWDAF, such as Distributed Machine Learning (DML), Federated Learning (FL), and regular ML.

### TECHNICAL FIELD

The present application relates generally to machine learning (ML) procedures, and more particularly to provisioning procedures for training ML models.

### BACKGROUND

Section 6.2A in 3GPP technical specification TS 23.288 (V.17.6.0) entitled “Architecture enhancements for 5G System (5GS) to support network data analytics services,” which is hereby incorporated by reference in its entirety, introduces the procedures for provisioning machine learning (ML) models. In this release of the specification, a Network Data Analytics Function (NWDAF) comprising an Analytics Logic Function (AnLF) is locally configured with a set of identifiers (IDs). The set of IDs identify the NWDAFs that contain a Model Training Logical Function (MTLF), as well as the Analytics ID(s) that are supported by each NWDAF containing a MTLF, to retrieve trained ML models. If necessary, a NWDAF containing an AnLF may utilize NWDAF discovery procedures to discover an NWDAF containing a MTLF that is identified by an ID contained in the set of locally configured IDs. An NWDAF containing an MTLF may determine that further training for an existing ML model is needed responsive to receiving a ML model subscription or a ML model request.

### SUMMARY

Embodiments of the present disclosure provide new parameters and procedures by which a server Network Data Analytics Function (NWDAF) having a Model Training Logical Function (MTLF) (hereinafter, “server NWDAF”) can select and approve one or more consumer Network Functions (NFs) having an Analytics Logical Function AnLF to participate in upcoming and/or ongoing machine learning (ML) model training processes.

In a first aspect, for example, the present disclosure provides a method for determining whether a consumer network function (NF) is approved to participate in training a machine learning (ML) model. The method is implemented by a network node functioning as the consumer NF and comprises sending a discovery request to a registry to discover a server Network Data Analytics Function (NWDAF). The discovery request indicates a capability of the consumer NF to support participation in training an ML model. The method also comprises subscribing to the server NWDAF and receiving a subscription response message from the server NWDAF. The subscription response message indicates whether the consumer NF is permitted to participate in the training of the ML model.

In a second aspect, the present disclosure provides a method for determining whether a consumer network function (NF) is approved to participate in training a machine learning (ML) model. In this aspect, the method is implemented by a network node functioning as a server Network Data Analytics Function (NWDAF) and comprises registering a profile of the server NWDAF with a registry. The profile indicates a capability of the server NWDAF to support participation of a consumer NF in the training of the ML model. The method further comprises receiving a subscription request from the consumer NF. The subscription request includes information related to one or both of an availability of data at the consumer NF to train the ML model and a capability of the consumer NF to evaluate the ML model. The method further comprises determining whether to allow the consumer NF to participate in the training of the ML model based on the information received in the subscription request, and then sending a subscription response message to the consumer NF indicating whether the consumer NF is allowed to participate in the training of the ML model.

In a third aspect, the present disclosure provides a network node configured to function as a consumer Network Function (NF). In this aspect, the network node comprises processing circuitry and a memory. The memory contains instructions executable by the processing circuitry whereby the network node is configured to send a discovery request to a registry to discover a server Network Data Analytics Function (NWDAF), wherein the discovery request indicates a capability of the consumer NF to support participation in training an ML model, subscribe to the server NWDAF, and receive a subscription response message from the server NWDAF, wherein the subscription response message indicates whether the consumer NF is permitted to participate in the training of the ML model.

In a fourth aspect, the present disclosure provides a network node configured to function as server Network Data Analytics Function (NWDAF). The network node in this aspect comprises processing circuitry and a memory. The memory contains instructions executable by the processing circuitry whereby the network node is configured to register a profile of the server NWDAF with a registry, wherein the profile indicates a capability of the server NWDAF to support participation of a consumer NF in the training of the ML model, receive a subscription request from the consumer NF, wherein the subscription request includes information related to one or both of an availability of data at the consumer NF to train the ML model and a capability of the consumer NF to evaluate the ML model, and determine whether to allow the consumer NF to participate in the training of the ML model based on the information received in the subscription request. So determined, the instructions are further configured the network node to send a subscription response message to the consumer NF indicating whether the consumer NF is allowed to participate in the training of the ML model.

In a fifth aspect, the present disclosure provides a method for selecting a consumer network function (NF) to evaluate a machine learning (ML) model prior to training the ML model. The method is implemented by a network node functioning as the consumer NF and comprises receiving a participation request message from a server Network Data Analytics Function (NWDAF). The participation request message comprises one or more parameters associated with the consumer NF participating in training the ML model. The method further comprises deciding to participate in training the ML model based on the one or more parameters received in the participation request message, and then sending a participation response message to the server NWDAF indicating that the consumer NF can participate in the training of the ML model.

In a sixth aspect, the present disclosure provides a method for selecting a consumer network function (NF) to evaluate a machine learning (ML) model prior to training of the ML model. In this aspect, the method is implemented by a network node functioning as a server Network Data Analytics Function (NWDAF) and comprises sending a participation request message to a consumer NF, wherein the participation request message comprises one or more parameters associated with the consumer NF participating in training the ML model, receiving a participation response message from the consumer NF indicating that the consumer NF is capable of participating in the training of the ML model, wherein the participation response message comprises at least one parameter of the one or more parameters sent to the consumer NF in the participation request message, and deciding that the consumer NF is allowed to participate in training the ML model based on the at least one parameter received in the participation response message. So decided, the method further comprises sending a participation confirmation message to the consumer NF indicating that the consumer NF is allowed to participate in the training of the MF model.

In a seventh aspect, the present disclosure provides a network node configured to function as a consumer Network Function (NF). The network node comprises processing circuitry and a memory. The memory contains instructions executable by the processing circuitry whereby the network node is configured to receive a participation request message from a server Network Data Analytics Function (NWDAF), wherein the participation request message comprises one or more parameters associated with the consumer NF participating in training the ML model, decide to participate in training the ML model based on the one or more parameters received in the participation request message, and send a participation response message to the server NWDAF indicating that the consumer NF can participate in the training of the ML model.

In an eighth aspect, the present disclosure provides a network node configured to function as server Network Data Analytics Function (NWDAF). In this aspect, the network node comprises processing circuitry and a memory. The memory contains instructions executable by the processing circuitry whereby the network node is configured to send a participation request message to a consumer NF, wherein the participation request message comprises one or more parameters associated with the consumer NF participating in training the ML model, receive a participation response message from the consumer NF indicating that the consumer NF is capable of participating in the training of the ML model, wherein the participation response message comprises at least one parameter of the one or more parameters sent to the consumer NF in the participation request message, decide that the consumer NF is allowed to participate in training the ML model based on the at least one parameter received in the participation response message, and send a participation confirmation message to the consumer NF indicating that the consumer NF is allowed to participate in the training of the MF model.

In a ninth aspect, the present disclosure provides a method for selecting a consumer network function (NF) to participate in training of a machine learning (ML) model. The method is implemented by a network node functioning as the consumer NF and comprises sending a participation announcement message to a server Network Data Analytics Function (NWDAF) indicating that the consumer NF can participate in training of a ML model, and receiving a participation confirmation message from the server NWDAF indicating that the consumer NF is allowed to participate in the training of the MF model.

In a tenth aspect, the present disclosure provides a method for selecting a consumer network function (NF) to participate in training of a machine learning (ML) model. The method is implemented by a network node functioning as a server Network Data Analytics Function (NWDAF) and comprises receiving a participation announcement message comprising one or more parameters from a consumer NF, wherein the one or more parameters indicate that the consumer NF can participate in training an ML model, deciding that the consumer NF can participate in the training of the ML model based on the one or more parameters received in the participation announcement message, and sending a participation confirmation message to the consumer NF indicating that the consumer NF is allowed to participate in the training of the MF model.

In an eleventh aspect, the present disclosure provides a network node configured to function as a consumer Network Function (NF). The network node comprises processing circuitry and a memory. The memory contains instructions executable by the processing circuitry whereby the network node is configured to send a participation announcement message to a server Network Data Analytics Function (NWDAF) indicating that the consumer NF can participate in training of a ML model and receive a participation confirmation message from the server NWDAF indicating that the consumer NF is allowed to participate in the training of the MF model.

In a twelfth aspect, the present disclosure provides a network node configured to function as a server Network Data Analytics Function (NWDAF). The network node comprises processing circuitry and a memory. The memory contains instructions executable by the processing circuitry whereby the network node is configured to receive a participation announcement message comprising one or more parameters from a consumer NF, wherein the one or more parameters indicate that the consumer NF can participate in training an ML model, decide that the consumer NF can participate in the training of the ML model based on the one or more parameters received in the participation announcement message, and send a participation confirmation message to the consumer NF indicating that the consumer NF is allowed to participate in the training of the MF model.

### BRIEF DESCRIPTION OF THE DRAWINGS

FIG. 1 is a signal flow diagram illustrating example messaging between a Network Data Analytics Function (NWDAF) service consumer having an Analytics Logic Function (AnLF) and a server NWDAF comprising a Model Training Logical Function (MTLF) for subscribing and unsubscribing to machine learning (ML) analytics according to aspects of the present disclosure.

FIG. 2 is a signal flow diagram illustrating example messaging between a NWDAF service consumer and a server NWDAF comprising a MTLF for requesting and obtaining information about an ML model according to aspects of the present disclosure.

FIGS. 3A-3B are signaling diagrams illustrating example messaging for with Federated Learning (FL) among multiple instances of a NWDAF according to aspects of the present disclosure.

FIG. 4 is a signaling diagram illustrating example messaging for providing FL training updates to a NWDAF service consumer from a server NWDAF according to aspects of the present disclosure.

FIGS. 5A-5B are signaling diagrams illustrating example messaging associated with a procedure for model performance guarantee during FL according to aspects of the present disclosure.

FIGS. 6 and 7A-7C are block diagrams illustrating respective systems in which one or more NWDAF service consumers interact with a server NWDAF according to aspects of the present disclosure.

FIG. 8 is a signaling diagram illustrating example messaging for approving a NWDAF service consumer to participate in the training of an ML model according to aspects of the present disclosure.

FIG. 9 is a signaling diagram illustrating example messaging for searching for and selecting one or more NWDAF service consumers to participate in the training of an ML model according to aspects of the present disclosure.

FIG. 10 is a signaling diagram illustrating example messaging for NWDAF service consumers to announce their ability to participate in the training of an ML model, and for a server NWDAF to select one or more of those NWDAF service consumers to participate in the training of an ML model according to aspects of the present disclosure.

FIG. 11 is a flow diagram illustrating a method, implemented by a network node functioning as a consumer Network Function (NF), for determining whether a consumer NF is approved to participate in training a ML model according to one aspect of the present disclosure.

FIG. 12 is a flow diagram illustrating a method, implemented by a network node functioning as a server NWDAF, for determining whether a consumer NF is approved to participate in training a ML model according to one aspect of the present disclosure.

FIG. 13 is a flow diagram illustrating a method, implemented by a network node functioning as a consumer NF, for selecting a consumer NF to evaluate a ML model prior to training the ML model according to one aspect of the present disclosure.

FIG. 14 is a flow diagram illustrating a method, implemented by a network node functioning as a server NWDAF, for selecting a consumer NF to evaluate a ML model prior to training of the ML model according to one aspect of the present disclosure.

FIG. 15 is a flow diagram illustrating a method, implemented by a network node functioning as a consumer NF, for selecting a consumer NF to participate in training of a ML model according to one aspect of the present disclosure.

FIG. 16 is a flow diagram illustrating a method implemented by a network node functioning as a server NWDAF, for selecting a consumer NF to participate in training of a ML model according to one aspect of the present disclosure.

FIG. 17A is a block diagram illustrating some of the components of a network node functioning as a server NWDAF according to one aspect of the present disclosure.

FIG. 17B is a block diagram illustrating some of the functional components of a computer program product executing on the processing circuitry of a server NWDAF according to one aspect of the present disclosure.

FIG. 18A is a block diagram illustrating some of the components of a network node functioning as a NWDAF service consumer according to one aspect of the present disclosure.

FIG. 18B is a block diagram illustrating some of the functional components of a computer program product executing on the processing circuitry of a NWDAF service consumer according to one aspect of the present disclosure.

### DETAILED DESCRIPTION

Embodiments of the present disclosure provide new parameters and procedures by which a server Network Data Analytics Function (NWDAF) having a Model Training Logical Function (MTLF) (hereinafter, “server NWDAF”) can select and approve one or more consumer Network Functions (NFs) having an Analytics Logical Function AnLF to participate in upcoming and/or ongoing machine learning (ML) model training processes. By way of example only, the ML model training could be any arbitrary ML format/architecture supported by NWDAF, such as Distributed Machine Learning (DML), Federated Learning (FL), and regular ML.

### Subscribing/Unsubscribing to ML Model Analytics

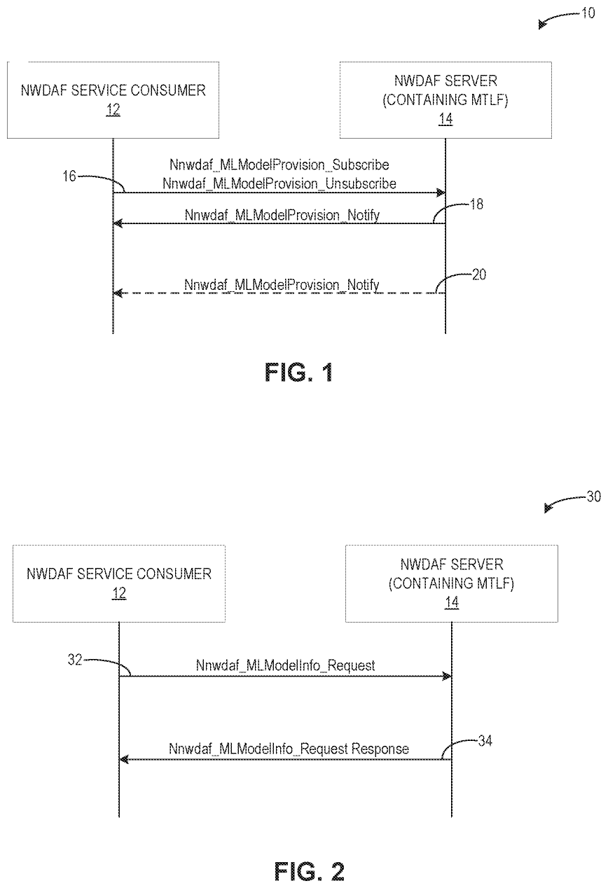

Turning now to the drawings, FIG. 1 illustrates example messaging 10 between a Network Data Analytics Function (NWDAF) service consumer 12 having an Analytics Logic Function (AnLF) and a server NWDAF 14 comprising a Model Training Logical Function (MTLF) for subscribing and unsubscribing to machine learning (ML) analytics according to aspects of the present disclosure. This procedure may be used, for example, by a NWDAF service consumer, (i.e., the NWDAF having an AnLF 12) to subscribe and unsubscribe to the server NWDAF 14 in order to be notified when ML model information associated with the analytics of a model becomes available using Nnwdaf_MLModelProvision services, as defined in clause 7.5 of TS 23.288 V.17.6.0, which is incorporated herein by reference in its entirety. The ML model information is used by the NWDAF service consumer to derive analytics. The service is also used by an NWDAF to modify existing ML model subscription(s). It should be understood that for the purposes of this disclosure, a NWDAF can be a consumer of a service provided by other NWDAF(s) and a provider of the service to other NWDAF(s).

As seen in FIG. 1, the NWDAF service consumer 12 subscribes to, modifies, or cancels subscription for a (set of) trained ML model(s) associated with a (set of) Analytics ID(s) by invoking a Nnwdaf_MLModelProvision_Subscribe or a Nnwdaf_MLModelProvision_Unsubscribe service operation. In the embodiment of FIG. 1, the NWDAF Service Consumer 12 invokes the Nnwdaf_MLModelProvision_Subscribe service operation to subscribe to ML model provisioning from a server NWDAF 14, or a Nnwdaf_MLModelProvision_Unsubscribe service operation to unsubscribe to ML model provisioning from server NWDAF 14 (line 16). The parameters that may be provided by the NWDAF service consumer 12 during these operations are described in more detail in Tables 1A and 1B below. Nevertheless, when a subscription for a trained ML model associated with an Analytics ID is received, the server NWDAF 14 may determine one or more aspects that include, but are not limited to:
whether an existing trained ML model can be used for the subscription; and
whether triggering further training for existing trained ML models is needed for the subscription.

If the server NWDAF 14 determines that further training is needed, the server NWDAF 14 may initiate data collection from one or more NFs to generate the ML model. For example, as described in section 6.2 of TS 23.288 V.17.6.0, such NFs may include an Access and Mobility Management Function (AMF), a Data Collection Coordination Function (DCCF), an Analytics Data Repository Function (ADRF), a User Equipment (UE) Application (via an Application Function (AF)), and/or Operations, Administration, and Maintenance (OAM) functions.

If the service invocation is for a subscription modification or subscription cancelation, the NWDAF service consumer 12 includes the identifier (i.e., a Subscription Correlation ID) to be modified when invoking the Nnwdaf_MLModelProvision_Subscribe service operation.

If the NWDAF service consumer 12 subscribes to a (set of) trained ML model(s) associated with a (set of) Analytics ID(s), the server NWDAF 14 notifies the NWDAF service consumer 12 with the model information for the trained ML (e.g., a set of file addresses of the trained ML model) by invoking the Nnwdaf_MLModelProvision_Notify service operation (line 20). The content of trained ML model information that may be provided by the server NWDAF is described in more detail in Table 2 below.

In some aspects, responsive to the invocation of the Nnwdaf_MLModelProvision_Subscribe service operation at line 16, the server NWDAF 14 may determine that a previously provided trained ML model required re-training. In such instances, the server NWDAF may then also invoke the Nnwdaf_MLModelProvision_Notify service operation (line 20) to notify a subscribed NWDAF service consumer of the availability of the re-trained ML model.

Additionally, or alternatively, the NWDAF service consumer 12 may, at line 16, invoke the Nnwdaf_MLModelProvision_Subscribe service operation to modify a subscription (i.e., by including Subscription Correlation ID). In such cases, the server NWDAF 14 may be configured to provide either a new trained ML model that is different than the previously provided trained ML model, or a re-trained ML model by invoking Nnwdaf_MLModelProvision_Notify service operation at line 20.

### Contents of ML Model Provisioning (TS 23.288 v.17.6.0 Section 6.2A.2)

As stated above, the consumer NFs of the ML model provisioning services (e.g., the NWDAF service consumers) may provide various input parameters when invoking the Nnwdaf_MLModelProvision_Subscribe and/or the Nnwdaf_MLModelProvision_UnSubscribe service operations. These parameters, which are described in more detail in sections 7.5 and 7.6 of TS 23.288 V.17.6.0, are listed below in Table 1A. Not all parameters are required, but rather, some are optional.

TABLE 1A
Information of the analytics for which
the requested ML model is to be used.

| Parameter(s) | Description |
|---|---|
| A list of Analytics ID(s) | Identifies the analytics for which the ML model |
| | is used. |
| [OPTIONAL] | Enables the selection of an ML model for |
| ML Model Filter | which the analytics identified by an Analytics |
| Information | ID is requested (e.g., S-NSSAI and Area of |
| | Interest). Parameter types in the model filter |
| | information for an ML are the same as the |
| | parameter types in the analytics filter |
| | information defined in the procedures. |
| [OPTIONAL] Target | Indicates the object(s) for which an ML model |
| of ML Model | is requested (e.g., specific UEs, a group of |
| Reporting | UE(s) or any UE (i.e. all UEs)). |

Table 1B lists the ML reporting information parameters according to the Event Reporting Information Parameter defined in Table 4.15.1-1 of 3GPP Technical Specification TS 23.502 V.17.6.0 entitled “Procedures for the 5G System (5GS); Stage 2,” which is incorporated herein by reference in its entirety. Note that the parameters listed in Table 1B are used only for the Nnwdaf_MLModelProvision_Subscribe service operation and, as in Table 1A, some parameters are optional.

TABLE 1B
ML Model Reporting Information Parameters.

| Parameter(s) | Description |
|---|---|
| [OPTIONAL] ML | indicates time interval [start, end] for |
| Model Target Period | which ML model for the Analytics is |
| | requested. The time interval is |
| | expressed with actual start time and |
| | actual end time (e.g. via UTC time) |
| A Notification Target Address | allowing to correlate notifications |
| (plus a Notification Correlation | received from the NWDAF containing |
| ID) as defined in section 4.15.1 | MTLF with this subscription |
| of 3GPP Technical Specification | |
| TS 23.502 V.17.6.0 | |

Additionally, the server NWDAF may provide output information to the NWDAF service consumer of the ML model provisioning service operations as is described in sections 7.5 and 7.6 TS 23.288 V.17.6.0. Such information comprises the notification correlation information and is provided by the server NWDAF 14, for example, in the Nnwdaf_MLModelProvision_Notify service operation only. The Validity period and Spatial validity parameters are determined by MTLF internal logic, and further, are a subset of the Age of Information (AoI) when provided in the ML Model Filter Information and of ML Model Target Period parameters (see Tables 1A-1B), respectively.

TABLE 2
ML model provisioning service operations
provided by the server NWDAF

| Parameter(s) | Description |
|---|---|
| ML Model Information | Includes the ML model file address (e.g. |
| | URL or FQDN) for the Analytics ID(s) |
| [OPTIONAL] Validity period | Indicates a time period during which the |
| | provided ML model information applies |
| [OPTIONAL] Spatial validity | Indicates the area where the provided ML |
| | model information applies. |

### ML Model Request (TS 23.288 v. 17.6.0 Section 6.2A.3))

FIG. 2 illustrates example messaging 30 between a consumer NF 12 (e.g., a NWDAF service consumer) and a server NWDAF 14 for requesting and obtaining information about an ML model according to aspects of the present disclosure using, for example, the Nnwdaf_MLModelInfo service operations defined in TS 23.288 v.17.6.0 section 7.6. The ML Model Information parameter is used by the consumer NF to derive analytics. As above, a given NWDAF can be, at the same time, both a consumer of a service provided by other NWDAF(s), as well as a provider of the service to other NWDAF(s).

As seen in FIG. 2, the NWDAF service consumer 12 (i.e., the consumer NF) requests a (set of) one or more ML model(s) associated with a (set of) Analytics ID(s) by invoking Nnwdaf_MLModelInfo_Request service operation (line 32). The parameters that may be provided by the NWDAF service consumer 12 during this service operation are listed in Tables 1A-1B above. Regardless, responsive to receiving the request, the server NWDAF may determine various aspects. By way of example only, the server NWDAF 14 may determine:
whether an existing trained ML Model can be used for the request; and
whether triggering further training for an existing trained ML models is needed for the request.

If the server NWDAF 14 determines that further training is needed, the server NWDAF may initiate data collection from one or more various NFs to generate the ML model. As stated above, and as described in section 6.2 of TS 23.288 V.17.6.0, the one or more NFs may include, but are not limited to, AMF, DCCF, ADRF, UE Application (via an AF), and/or OAM functions.

Upon receiving the Nnwdaf_MLModelInfo_Request service operation at line 32, the server NWDAF 14 responds to the NWDAF service consumer 12 by invoking the Nnwdaf_MLModelInfo_Request response service operation (line 34). This operation provides the NWDAF service consumer 12 with the ML Model Information, which comprises a (set of) file addresses of the trained ML model. The content of ML Model Information that can be provided by the server NWDAF 14 in the Nnwdaf_MLModelInfo_Request response service operation is listed and described above in Table 2.

### NWDAF Service Consumer Involvement in FL Among Multiple NWDAF Instances in 5GC

The 3GPP technical specification TR 23.700-81 (V.1.1.0) entitled, “Study of Enablers for Network Automation for 5G System (5GS); Phase 3,” which is incorporated herein by reference in its entirety, considers the role of NWDAF service consumers in the FL process among multiple NWDAF Instances in 5GC. By way of example only, such considerations are discussed in connection with solutions #24, #52, and #69 in TR 23.700-81 (V.1.1.0).

### NWDAF Service Consumer Involvement in FL in Solution #24

In TR 23.700-81 (V.1.1.0), solution #24 addresses Key Issue #8 (i.e., “Supporting Federated Learning in 5GC”). This solution particularly proposes that, during the FL training process and based on a request received from a consumer NF, the server NWDAF inform the consumer NF (e.g., the NWDAF service consumer) of the training status for a ML model. So informed, the customer NF could modify its subscription to the server NWDAF for new model requirement. The server NWDAF will then update or terminate the FL training process accordingly.

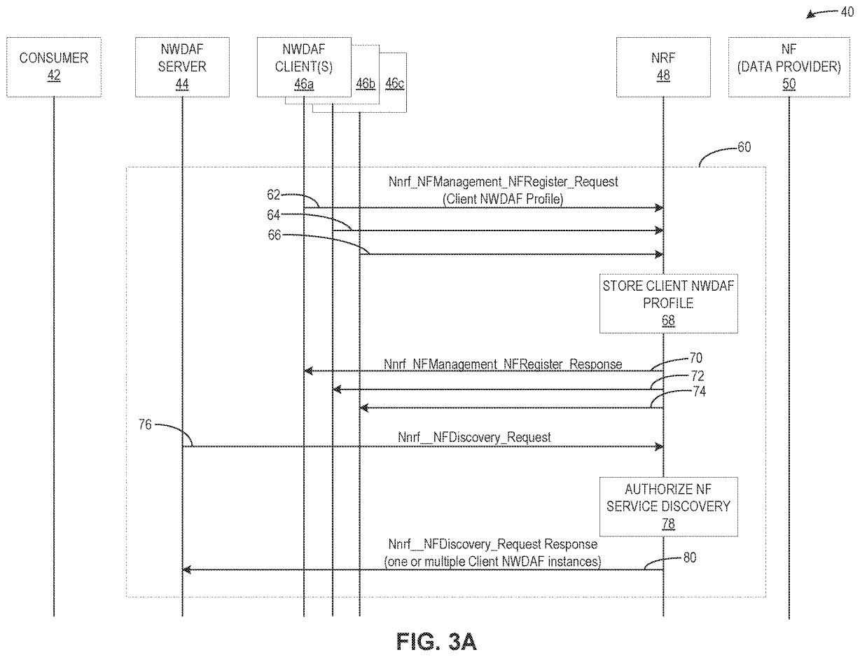

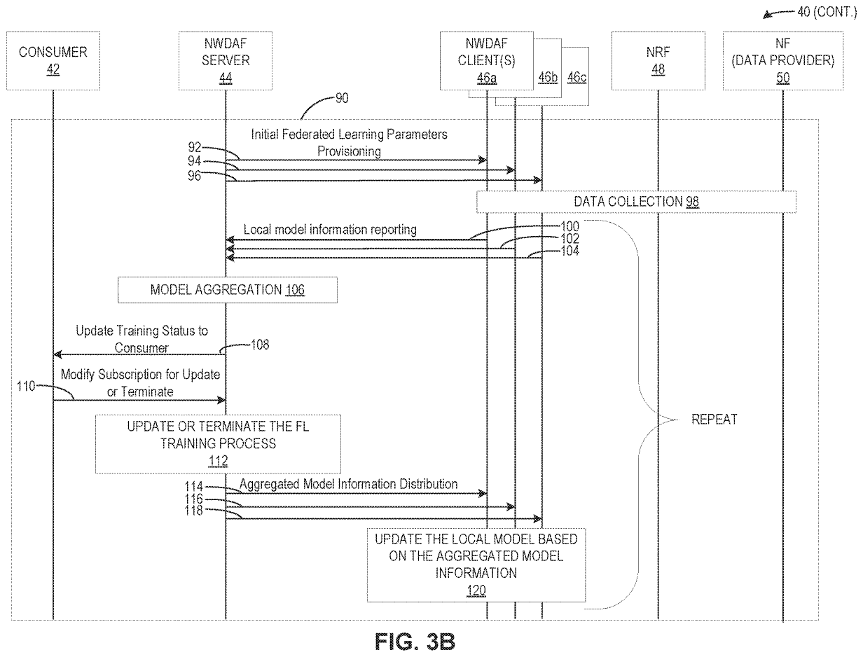

FIGS. 3A-3B illustrate example messaging 40 for such an FL process among multiple instances of a NWDAF according to aspects of the present disclosure. As seen in FIG. 3A, in a NWDAF Registration and Discovery phase 60, one or more consumer NF instances 42a, 42b, 42c (e.g., client NWDAFs such as the NWDAF service consumers 12) invokes a Nnrf_NFManagement_NFRegister_request service operation to register their respective Client NWDAF profiles with a Network Repository Function (NRF) (lines 62, 64, 66). As described in TS 23.502 section 5.2.7.2.2, the Client NWDAF profile is of a Client NWDAF type and includes, as parameters, an Address of the consumer NF, information related to its capability to support of FL, one or more Analytics IDs, and a service area. Upon receipt of each request, the NRF stores the profile of each consumer NF instance 46a, 46b, 46c profile (box 68) and responds to the consumer NF instances 46a, 46b, 46c by invoking corresponding Nnrf_NFManagement_NFRegister_response service operations (lines 70, 72, 74).

Additionally, a server NWDAF 44 may invoke a Nnrf_NFDiscovery_Request service operation to the NRF 48 to discover one or more consumer NF instances 46a, 46b, 46c that could be used for FL (line 76). This service operation allows the server NWDAF 44 to obtain the IP addresses of the consumer NF instances 46a, 46b, 46c and includes one or more parameters including one or more Analytics IDs, capability information regarding the consumer NF instances' 46a, 46b, 46c abilities to support of FL, and a service area. Upon receipt, the NRF 48 authorizes the NF service discovery (box 78) and responds by invoking an Nnrf_NFDiscovery_RequestResponse service operation that provides the instances (i.e., the IP addresses) of the consumer NFs that support the Analytics ID(s) provided by the server NWDAF (line 80).

It may be assumed in some embodiments that the Analytics IDs provided by the server NWDAF 44 are preconfigured for a type of FL. Thus, based on this pre-configuration, the NRF 48 is able to determine that the server NWDAF 44 sending the request will perform federated learning. As stated above, the NRF 48 responds to the server NWDAF 44 with the IP address(es) of the one or more consumer NF instances 46a, 46b, 46c that support the provided Analytics ID(s). Note that in some instances, the Analytic ID(s) supporting FL are configured by a network operator. Regardless, the server NWDAF 44 selects which consumer NF instances 46a, 46b, 46c will participate in the FL training of a given ML model based on the response from NRF 48.

In a Federated Learning Training phase 90, server NWDAF 44 then sends a request (an Initial FL Parameters Provisioning request) to the selected consumer NF instances 46a, 46b, 46c that participate in the FL (lines 92, 94, 96). The request may include parameters such as information identifying an initial ML model, a data type list, a maximum response time window, and the like, to assist the local model training for FL. In one embodiment, this step is aligned with the outcome of Key Issue #8 addressed in solution #24 described in TR 23.700-81 (V.1.1.0).

Each consumer NF instance 46a, 46b, 46c then collects its local data by using the current mechanism described in section 6.2 of TS 23.288 v. 17.6.0 (box 98). Then, during the FL training procedure, each consumer NF instance 46a, 46b, 46c trains a ML model retrieved from the server NWDAF 44 based on its own data, and reports the results of the ML model training (e.g., the gradient) to the server NWDAF 44 (lines 100, 102, 104). The trained models/parameters are shared/exchanged among multiple consumer NF instances 46a, 46b, 46c during the FL training process using the Nnwdaf_MLAggregation service operation or the extended Nnwdaf_MLModelProvision service operation, as defined in section 6.24.3 of TR 23.700-81 (V.1.1.0). Only one of the options should be chosen for the normative phase.

Upon receipt of the results of the ML model training, the server NWDAF 44 aggregates all the local ML model training results retrieved in lines 100, 102, 104, such as the gradient, to update the global ML model (box 106). Then, based on the consumer NF instance 46a, 46b, 46c request, the server NWDAF 44 updates the training status (e.g., an accuracy level) to the consumer NF using Nnwdaf_MLModelProvision_Notify service operation (line 108). The updates may occur periodically (e.g., each round of training, multiple rounds of training, every 10 min, etc.) or dynamically, such as when some pre-determined status (e.g., an accuracy level) is achieved. Optionally, the consumer NF instance 46a, 46b, 46c may determine whether the current ML model can satisfy a given requirement (e.g., accuracy and time). If so, the consumer NF instance 46a, 46b, 46c may modify its subscription (line 110). Regardless, according to the request from the consumer NF instance 46a, 46b, 46c, the server NWDAF 44 updates or terminates the current FL training process by invoking an Nnwdaf_MLAggregation_Modify or an Nnwdaf_MLAggregation_Terminate service operation (box 112).

If the FL procedure continues, however, the server NWDAF 44 sends the aggregated ML model information (e.g., the updated ML model) to each consumer NF instance 46a, 46b, 46c for the next round of ML model training (lines 114, 116, 118). In one aspect, this is accomplished by the server NWDAF 44 invoking an Nnwdaf_MLAggregration_Notify/Nnwdaf_MLModelProvision_Notify service operation. Upon receipt, each consumer NF instance 46a, 46b, 46c updates its own ML model based on the aggregated model information (e.g., an updated ML model) distributed by the server NWDAF 44 (box 120). In at least one aspect of the present disclosure, a part of the Federated Learning Training phase 90 (i.e., the part of the process from line 100 through box 120) is repeated until a training termination condition is reached (e.g., when a maximum number of iterations is reached or the result of a loss function is lower than a threshold). Regardless, once the ML training procedure is finished, the globally optimal ML model or ML model parameters may be distributed to the consumer NFs for the inference.

### NWDAF Service Consumer Involvement in FL in Solution #52

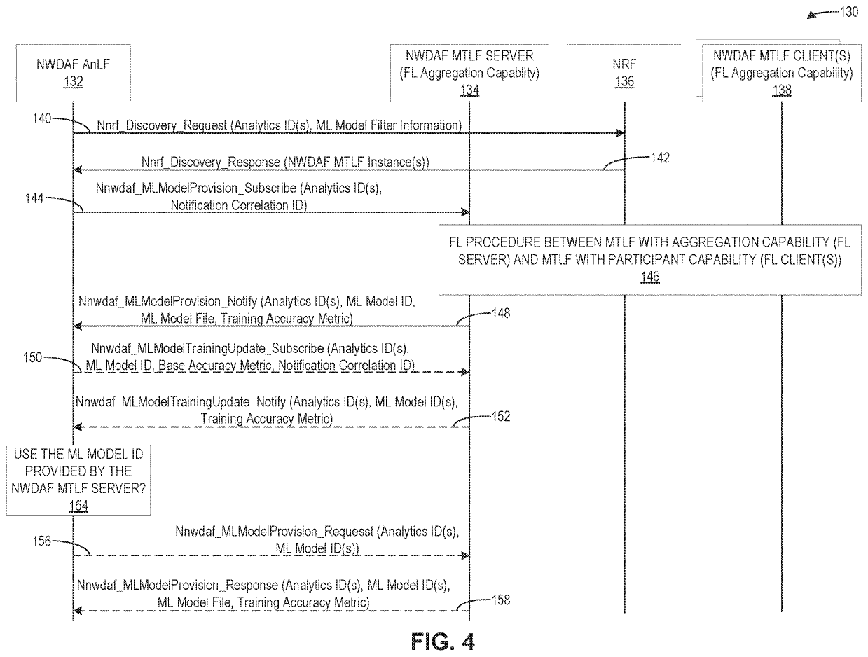

FIG. 4 illustrates example messaging 130 for providing FL training updates to a consumer NF (e.g., a NWDAF service consumer) from a server NWDAF according to aspects of the present disclosure. TR 23.700-81 (V.1.1.0) proposes solution #52 for Key Issue #8 to support the FL procedure between different server NWDAFs and to provide FL training updates from a server NWDAF (e.g., a NWDAF with FL aggregation capability/performing the role of FL server) to one or more consumer NFs (e.g., one or more NWDAFs, each containing a respective AnLF). An example procedure for FL training updates from a server NWDAF (e.g., a NWDAF comprising a MTLF) to a consumer NF (e.g., a NWDAF comprising a AnLF) is described in section 6.52.2 in TR 23.700-81 (V.1.1.0). It should be noted here that the aspects related to the sharing of the trained ML model(s) should be aligned with Key Issue #5.

As seen in FIG. 4, a consumer NF 132 (e.g., an NWDAF containing a AnLF) discovers one or more instances of a server NWDAF 134 (e.g., a NWDAF containing a MTLF) via the NRF 136 (lines 140, 142, 144). In particular, the consumer NF 132 invokes a Nnrf_Discovery_Request service operation with the NRF 136 providing one or more Analytics IDs and ML Model Filter Information as parameters (line 140). The NRF 136 then responds by invoking a Nnrf_Discovery_Response service operation providing, as parameters, the IP addresses of one or more server NWDAF 134 instances (line 142). Additionally, or alternatively, the consumer NF 132 may invoke a Nnwdaf_MLModelProvision_Subscribe service operation to a server NWDAF 134 providing one or more Analytics IDs and a Notification Correlation ID as parameters (line 144).

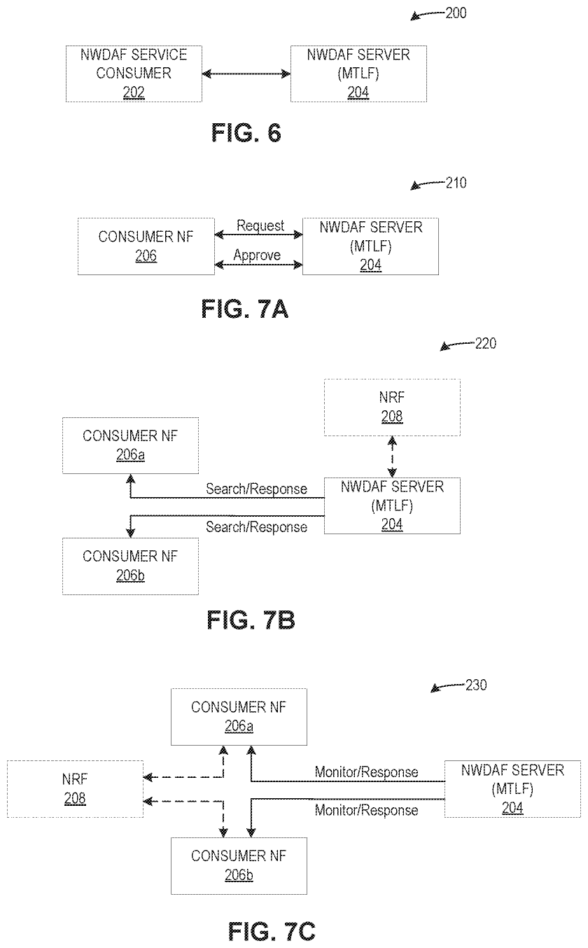

So discovered, FL training between a server NWDAF with Federated aggregation capability and a server NWDAF with Federated participation capability is performed as described in solution #21 of TR 23.700-81 (V.1.1.0) (see e.g., FIG. 6.21.2.3-1) or in solution #23 of TR 23.700-81 (V.1.1.0) (see e.g., FIG. 6.23.2-1) (box 146). Additionally, the server NWDAF 134 with Federated participation capability sends its local training accuracy metrics via a Nnwdaf_MLModelTraining_Notify service operation (see e.g., FIG. 6.23.2-1 of TR 23.700-81 (V. 1.1.0)) or an exchange ML model parameters procedure (e.g., step 11 in FIG. 6.23.2-1 of TR 23.700-81 (V. 1.1.0).

The server NWDAF 134 then sends a Nnwdaf_MLmodelProvision_Notify message with Analytics ID(s), ML model ID(s), ML model file address(es), ML model serialization format(s), and Training Accuracy metrics per ML model ID (line 148). The training accuracy metrics indicate the ML model accuracy when the server NWDAF performs training using training a dataset. In this embodiment, the training accuracy metric is calculated by the server NWDAF 134 with Federated aggregation capability by aggregating the local training accuracy metrics received in connection with box 146 of FIG. 4.

The consumer NF 132 (e.g., the NWDAF comprising a AnLF) then conditionally sends a Nnwdaf_MLModelTrainingUpdate_Subscribe message to the server NWDAF 134 with parameters including one or more Analytics ID(s), ML model ID(s), a Base Accuracy metric, and one or more Notification Correlation IDs (line 150). In this embodiment, the same ML model ID(s) that were provided in line 148 of FIG. 4 are also included in the Nnwdaf_MLModelTrainingUpdate_Subscribe message sent to the server NWDAF 134. The Base Accuracy metric is an accuracy metric determined by the consumer NF 132 using the dataset from a live network, and is provided by the consumer NF 132 to notify the server NWDAF 134. Specifically, the server NWDAF 134 is notified when the same ML model that was in line 148 of FIG. 4, or a new ML model (e.g., for a given Analytics ID), is available with a training accuracy that is higher than the Base Accuracy metric. In at least one embodiment, the Accuracy metrics that are used in the embodiment depend on a conclusion of Key Issue #1 in TR 23.700-81 (V.1.1.0), which is similar to accuracy or Multi Access Edge (MAE).

Server NWDAF 134 then conditionally responds to the consumer NF 132 by sending a Nnwdaf_MLModelTrainingUpdate_Notify message with one or more Analytics ID(s), ML model ID(s), and Training Accuracy metric(s) to the consumer NF (line 152). The ML model ID(s) included in the message may be the same re-trained ML model as provided in line 148 with new training accuracy higher than the Base Accuracy metric provided in line 150. Additionally, or alternatively, the ML model ID(s) may be those of a new trained ML model available for the Analytics ID(s) provided in line 150 with training accuracy level higher than the Base Accuracy metric.

The consumer NF 132 then conditionally decides whether it wants to use the ML model ID provided in step 4 (box 154). If so, the consumer NF 132 conditionally sends a Nnwdaf_MLModelProvision_Request message with the Analytics ID(s) and the ML model ID(s) provided in line 152 (line 156). The server NWDAF 134 then conditionally sends a Nnwdaf_MLModelProvision_Response message with Analytics ID(s), ML model ID(s), ML model file address(es), and Training Accuracy metrics to the consumer NF (line 158).

### NWDAF Service Consumer Involvement in FL in Solution #69

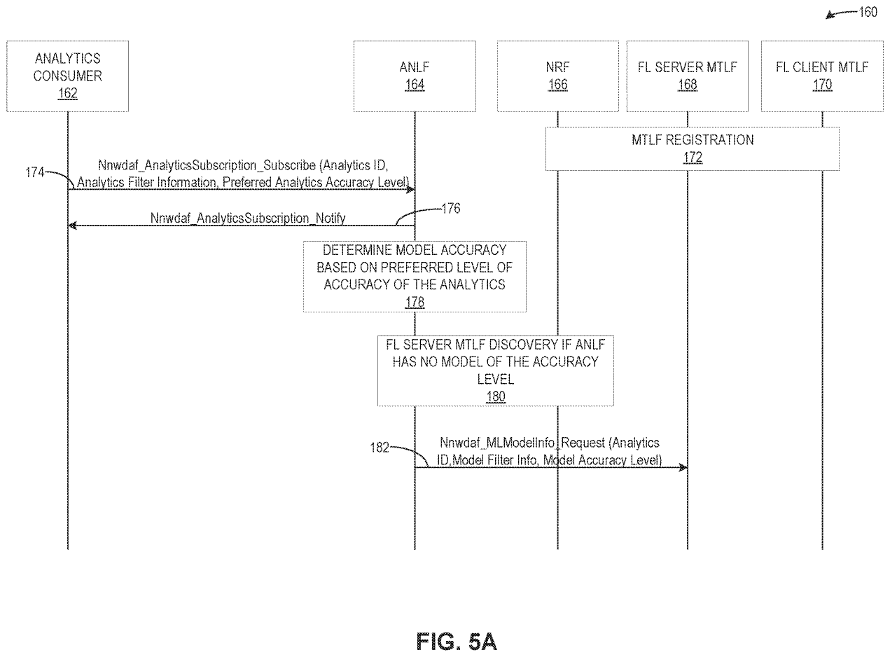

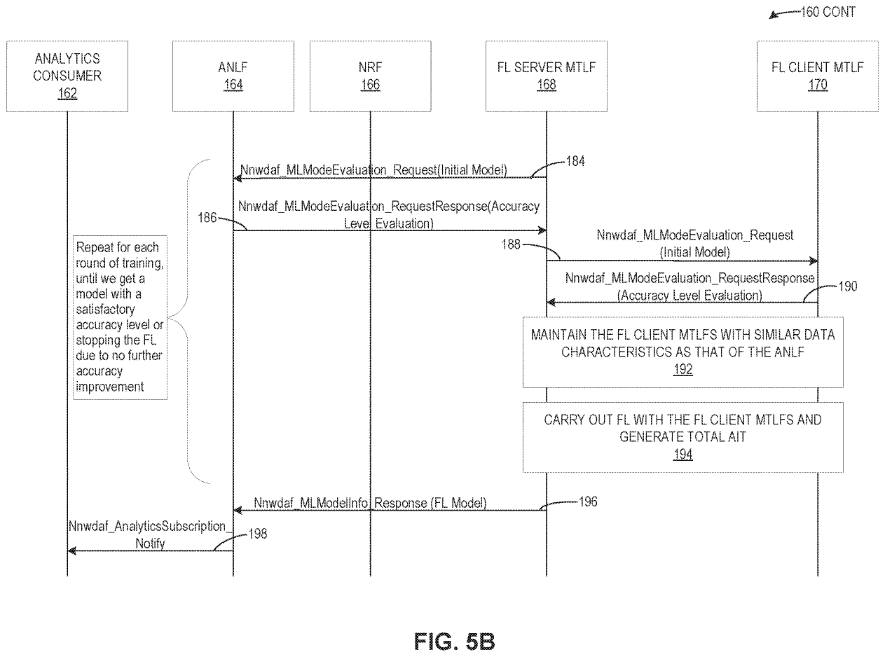

Solution #69 of TR 23.700-81 (V.1.1.0) is proposed for Key Issue #8 in TR 23.700-81 (V.1.1.0) on FL among multiple NWDAF instances. In more detail, solution #69 proposes that a consumer NF (e.g., a NWDAF service consumer having a AnLF) calculate an “Accuracy-in-Use” metric during the FL training process and send the calculated results to an FL server with a MTLF. Accordingly, FIGS. 5A-5B illustrate example messaging 160 associated with a procedure for model performance guarantee during FL according to aspects of the present disclosure.

It should be noted that, as a pre-condition, the server NWDAFs 168 (e.g., a FL Server or FL Client) registers with the NRF 166 with the “FL capability” support information (box 172). Particularly, the server NWDAFs 168 may register in the NRF 166 with the information of available ML model, such as the Analytics ID, Model Filter information, and Model Accuracy Level of the available ML model.

A consumer NF, such as an Analytics Consumer 162, then requests the NWDAF for analytics subscription (line 174). For example, in one embodiment, the analytics consumer NF 162 receives a Nnwdaf_AnalyticsSubscription_Subscribe request from an AnLF 164 (line 176). The request message in this embodiment may indicate a preferred level of accuracy for the analytics as required by the analytics consumer NF 162. Upon receipt, the AnLF 164 accepts the subscription and sends a Nnwdaf_AnalyticsSubscription_Subscribe response to the analytics consumer NF 162.

The AnLF 164 then derives the Analytics ID, Model Filter information, and Model Accuracy Level information from the Analytics ID, Analytics Filter information, and preferred level of accuracy of the analytics received from the analytics consumer NF 162 (box 178). If the AnLF 164 has no model satisfying the derived Analytics ID, Model Filter information, and Model Accuracy Level, the AnLF will try to discover a MTLF with the required model (box 180). If the discovered MTLF can provide or train a model that meets the Model Accuracy Level, the AnLF 164 can get the model for the analytics and proceed directly to line 198 (FIG. 5B). In this case, FL is not required. If there is no MTLF that can provide the model with the required Model Accuracy Level, the AnLF 134 discovers a MTLF supporting a FL Server (i.e., a MTLF registers in the NRF with the “FL capability” of FL server). In such cases, FL is required.

The AnLF 164 sends the Nnwdaf_MLModelInfo_Request to the FL Server MTLF 168 and provides, as parameters in this message, one or more Analytics IDs, Model Filter Information, and Model Accuracy Level information (line 182). The FL Server MTLF 168 then discovers one or more candidate FL Client MTLFs 170 from the NRF 166 and add them into the Federated Learning group.

The FL Server MTLF 168 delivers the initial/common model to the AnLF 164 for accuracy evaluation before each iteration of FL by invoking the Nnwdaf_MLModelEvaluation_Request service operation (line 184). Additionally, the AnLF 164 evaluates the accuracy level of the initial/common model with the collected data in history as the validation dataset. In at least one embodiment, the AnLF 164 provides the Accuracy-in-Use of the initial/common model to the FL Server MTLF by invoking Nnwdaf_MLModelEvaluation_Request Response operation (line 186).

The FL Server MTLF 168 then delivers the initial/common model to each of the FL Client MTLFs 170 for an accuracy evaluation before each iteration of FL by invoking the Nnwdaf_MLModelEvaluation_Request operation (line 188). The FL Client MTLFs 170 evaluate the accuracy level of the initial/common model with the local training data as the validation dataset and provide the Accuracy-in-Training value of the initial/common model to the FL Server MTLF by invoking a Nnwdaf_MLModelEvaluation_Request Response operation (line 190).

The FL Server MTLF 168 then compares the Accuracy-in-Training of the initial/common model from the FL Client MTLFs 170 against the Accuracy-in-Use of the initial/common model from the AnLF (box 192). If the Accuracy-in-Training calculated by a FL Client MTLF 170 is much different from the Accuracy-in-Use calculated by the AnLF 166, it can be assumed that the characteristics of the local dataset of the MTLF would be different from the characteristics of the data used by the AnLF 166. Therefore, the FL server MTLF 168 can remove the FL Client MTLF 170 from the FL group.

The FL Server MTLF 168 then performs this iteration of the FL with the FL Client MTLFs 170 in the FL group and generates the total Accuracy-in-Training by aggregating the received Accuracy-in-Training (box 194). Note that in one aspect, the FL Server MTLF 168 repeats the part of method 160 from line 184 to box 194 for each iteration of FL, until it receives a model with a satisfactory accuracy level. The FL Server MTLF 168 may stop to begin a new iteration of FL responsive to determining that there is no improvement accuracy.

The FL Server MTLF 168 provides the model getting from the FL to the AnLF 164 by invoking a Nnwdaf_MLModelInfo_Response service operation (line 196). Then, using the model received from the FL, the AnLF 166 provides analytics outputs to the analytics consumer NF 162 by invoking a Nnwdaf_AnalyticsSubscriptionNotify message (line 198).

In the solutions given in TR 23.700-81 (V.1.1.0), the consumer NFs (e.g., NWDAF service consumers having a AnLF) involvement in FL (i.e., solutions #24, #52, and #69) is considered to guarantee and improve trained ML model performance. However, these solutions are still unclear as to how the server NWDAF obtains information from the consumer to participate in a ML model training process. Further, these solutions do not indicate how a server NWDAF selects a consumer NF (e.g., an AnLF) to participle in the ML model training process in cases where there is more than one consumer NF (e.g., multiple AnLFs) available. Additionally, these solutions do not address the corresponding interactions between the consumer NF and the server NWDAF before and/or during the training process for obtaining information, approving, and selecting one or more appropriate consumer NFs.

Embodiments of the present disclosure address these, and other, shortcomings. Particularly, the present embodiments provide new parameters and procedures for a server NWDAF to use when approving and selecting appropriate consumer NFs to participate in upcoming/ongoing ML model training processes. The new parameters include those that define:
A capability for supporting a consumer NF's participation in ML model training;
An indication of the availability of real use data, test data, and validation data;
An indication of the capability to evaluate an initial ML model, an intermediate ML model, and/or a final ML model (e.g., test/validation on ML model accuracy, preciseness, etc.); and
A participation mode. In at least one embodiment, the possible participation modes for a consumer NF in a ML model training process include:
   Mode A: Indicates participation in evaluating the status of an ML model. According to the present embodiments, ML model status evaluation is different from ML model evaluation. That is, a server NWDAF performs an evaluation on the ML model and provides an updated status of the ML model to the consumer NF, as introduced in Solution #24 of TR 23.700-81 (V. 1.1.0);
   Mode B: Substantially continuous participation in each round of training for ML model evaluation;
   Mode C: Periodic participation in the training for ML model evaluation (e.g., every n rounds where n>1);
   Mode D: One time participation in the training for ML model evaluation when triggered by a server NWDAF; and
   Mode E: Participation in a final ML model evaluation.

Additionally, the present embodiments provide new interactions and corresponding procedures that occur between a server NWDAF and a consumer NF. For example, the following situations are considered for the server NWDAF to approve and select appropriate consumer NFs for participation in a ML model training process.
In a consumer NF request, the server NWDAF approves the consumer NF for participation in an upcoming/ongoing ML model training process;
The consumer NF is also chosen by the server NWDAF to participate in an upcoming/ongoing ML model training process. This process may occur, for example, in the context of the following scenarios:
   Case 1: When a server NWDAF searches for and selects one or more appropriate consumer NFs; and
   Case 2: When a server NWDAF monitors for and receives announcements from consumer NFs, and subsequently selects one or more of the consumer NFs.

As explained in more detail below, by providing these new parameters and procedures, the present embodiments provide benefits and advantages that conventional solutions cannot or do not provide.

FIGS. 6 and 7A-7C are block diagrams illustrating respective systems 200, 210, 220, 230 in which one or more NWDAF service consumers interact with a server NWDAF according to aspects of the present disclosure. More particularly, FIG. 6 illustrates the communicative interaction between a NWDAF service consumer 202 and a server NWDAF 204, and FIGS. 7A-7C illustrate the communicative interaction between one or more consumer NFs 206 and a server NWDAF 204, and in some cases (e.g., FIG. 7B), a NRF 208.

The present embodiments consider two situations for NWDAF service consumers (i.e., consumer NFs) to participate in ML model training. These situations are:
1. When a server NWDAF approves a consumer NF to participate in an upcoming/ongoing ML model training process upon receiving a request from the consumer NF; and
2. When a server NWDAF selects a consumer NF to participate in an upcoming/ongoing ML model training process.

More particularly, FIG. 7A corresponds to a situation where a consumer NF 206 sends a request to a server NWDAF 204 requesting participation in an upcoming/ongoing ML model training process, and in response, the server NWDAF 204 approves the consumer NF 206 for participation in that process. As described later in more detail, the server NWDAF 204 decides whether to allow the consumer NF 206 to participate in the upcoming/ongoing ML model training process under an agreed-upon ML training participation mode.

FIGS. 7B and 7C correspond to a situation where the server NWDAF 204 selects an approved consumer NF 206a, 206b to participate in the upcoming/ongoing ML model training process. In this context, there are two cases in which a server NWDAF 204 selects a given consumer NF 206a, 206b for participation in an upcoming/ongoing ML model training process. Specifically:
Case 1: The server NWDAF 204 searches for and selects one or more consumer NFs 206a, 206b, as shown in FIG. 7B. In this case, the server NWDAF 204 searches for available consumer NFs 206a, 206b. After receiving responses from one or more consumer NFs 206a, 206b, the server NWDAF 204 decides which of the consumer NFs 206a, 206b could participate an ML model training process under agreed participate mode and indicates that selection to the consumer NFs 206a, 206b.
Case 2: The server NWDAF 204 monitors for announcements made by the consumer NFs 206a, 206b and selects consumer NFs 206a, 206b, as shown in FIG. 7C. In this case, a server NWDAF 204 monitors the announcements sent by one or more consumer NFs 206a, 206b indicating their ability to participate in an upcoming/ongoing ML model training process. After receiving the announcements, the server NWDAF 204 decides which consumer NFs 206a, 206b are capable of participating in the ML model training process under agreed participate mode and indicates those selections to the consumer NFs 206a, 206b.

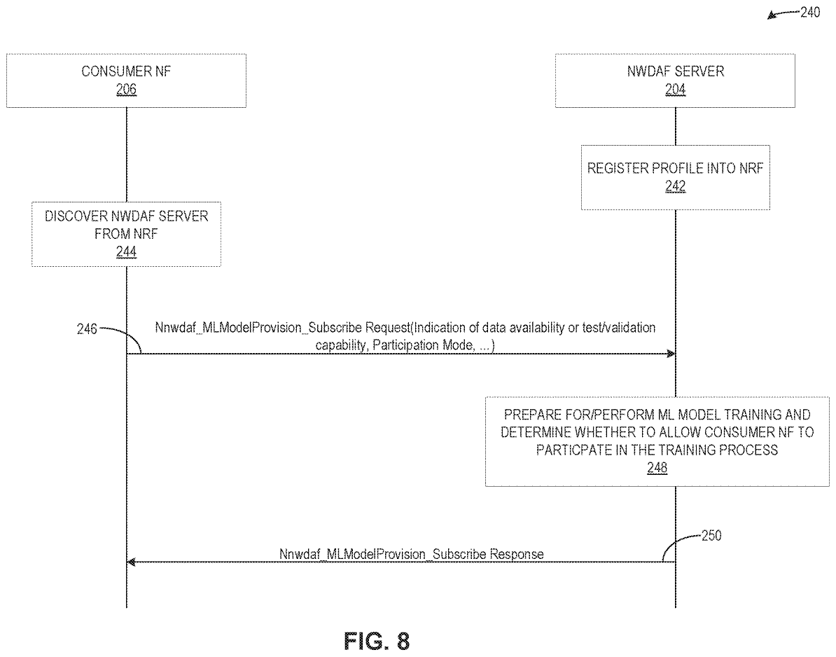

FIG. 8 illustrates example messaging 240 by which a server NWDAF 204 approves a consumer NF 206 (e.g., a NWDAF service consumer having an AnLF) for participation in an upcoming/ongoing ML model training process under an agreed-upon ML training participation mode according to one or more embodiments of the present disclosure.

As seen in FIG. 8, a server NWDAF 204 first registers its NWDAF profile in a registry, such as the NRF, for example (box 242). In addition to the conventional NRF registration elements of the NWDAF profile, the present embodiments configure the server NWDAF 204 to also provide the following elements when registering its profile.
Information indicating the capability of the server NWDAF 204 to support the participation of a consumer NF 206 in an ML model training process; and
If available, a supported participation mode.

A consumer NF 206 then discovers the server NWDAF 204 from the registry (box 244). For example, in this embodiment, the consumer NF 206 invokes the Nnrf_NFDiscovery_Request service operation to discover the server NWDAF 204. In addition to the parameters that are normally sent in the Nnrf_NFDiscovery_Request service operation, the present embodiments configure the consumer NF 206 to also provide the following parameters in the discovery request.
Information indicating the capability of the consumer NF 206 to participate in an ML model training process; and
A supported participation mode.

The consumer NF 206 then initiates a subscription to the server NWDAF 204 by invoking, for example, the Nnwdaf_MLModelProvision_Subscribe request service operation (line 246). In addition to the parameters that are normally provided with this request, the present embodiments configure the consumer NF 206 to also provide:
An indication regarding the availability of one or more of data that has been actually used, data used for testing, and data used for validation;
An indication of the capability of the consumer NF to evaluate initial ML models, intermediate ML models, and/or final ML models. Such evaluation includes, but is not limited to, evaluation of the testing and/or validation of the accuracy and/or preciseness of an ML model; and
A supported participation mode. As stated above, the possible participation modes for a consumer NF 206 in a ML model training process include:
   Mode A: Indicates participation in evaluating the status of an ML model. According to the present embodiments, ML model status evaluation is different from ML model evaluation. That is, a server NWDAF 204 performs an evaluation on the ML model and provides an updated status of the ML model to the consumer NF 206, as introduced in Solution #24 of TR 23.700-81 (V.1.1.0);
   Mode B: Substantially continuous participation in each round of training for ML model evaluation;
   Mode C: Periodic participation in the training for ML model evaluation (e.g., every n rounds where n>1);
   Mode D: One time participation in the training for ML model evaluation when triggered by a server NWDAF 204; and
   Mode E: Participation in a final ML model evaluation.

In addition to the operations for preparing and/or performing an ML model training process, the present embodiments also configure the server NWDAF 204 to further decide whether to allow the consumer NF 206 to participate in the upcoming/ongoing ML model training process (box 248). In at least one embodiment, the decision is made according to training logic at the server NWDAF 204, one or more local policies at the server NWDAF 204, and the information provided in the request from the consumer NF 206.

The server NWDAF 204 then responds to the consumer NF 206 indicating whether the consumer NF 206 is allowed to participate in the ML model training process (line 250). As seen in FIG. 8, for example, server NWDAF 204 invokes the Nnwdaf_MLModelProvision_Subscribe response service operation. According to the present embodiments, the server NWDAF 204 is configured to provide the requesting consumer NF 206 with the following information in addition to the information conventionally sent with this message.
An indication of whether the consumer NF 206 is or is not allowed to participate into the ML model training process; and
A supported participation mode for the consumer NF 206 to use when participating in the upcoming/ongoing ML model training process.

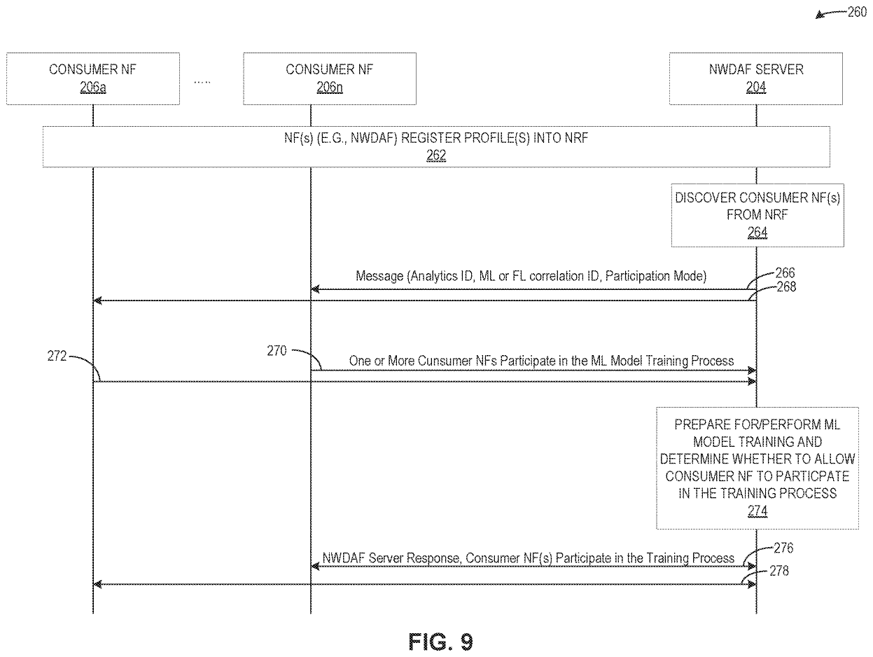

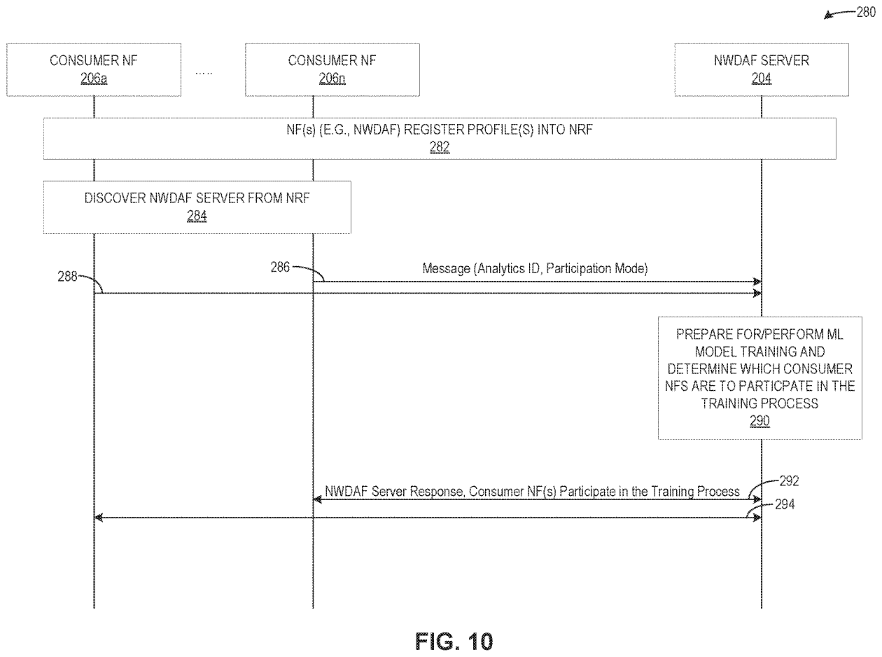

FIGS. 9 and 10 illustrate example messaging by which appropriate consumer NFs 206a-206n are identified and selected for participation in an upcoming/ongoing ML model training process. In particular, there are two cases in which a server NWDAF 204 selects a given consumer NF 206a-206n for participation in an upcoming/ongoing ML model training process. These are:
Case 1: When the server NWDAF 204 searches for and selects one or more consumer NFs 206a-206n (e.g., as shown in FIG. 7B and FIG. 9); and
Case 2: When the server NWDAF 204 monitors for announcements made by the consumer NFs 206a-206n and selects consumer NFs 206a-206n (e.g., as shown in FIG. 7C and FIG. 10).

Particularly, FIG. 9 illustrates example messaging 260 for by which a server NWDAF 204 searches for and selects one or more consumer NFs 206a-206n (e.g., NWDAF service consumers having AnLFs) to participate in an upcoming/ongoing ML model training process according to embodiments of the present disclosure. As seen in FIG. 9, each of the consumer NFs 206a-206n and the server NWDAF 204 first registers its respective profile in a registry, such as an NRF, for example (box 262). In addition to the conventional NRF registration elements, the present embodiments configure the server NWDAF 204 to also provide the following elements.
Information indicating the capability of the server NWDAF 204 to support the participation of a consumer NF 206a-206n in an ML model training process; and
If available, a supported participation mode.

Additionally, the present embodiments configure each of the consumer NFs 206a-206n to also provide the following registration elements.
Information indicating the capability of the consumer NF 206a-206n to participate in an ML model training process; and
A supported participation mode.

In some situations, the server NWDAF 204 may need to discover consumer NFs 206a-206n from registry (e.g., the NRF) (box 264). In such cases, the server NWDAF 204 is configured according to the present embodiments to invoke the Nnrf_NFDiscovery_Request service operation, as previously described. According to the present disclosure, the server NWDAF 204 is configured to provide the following parameters, in addition to those that conventionally exist, in the discovery request.
Information indicating the capability of the server NWDAF 204 to support the participation of a consumer NF 206a-206n in an ML model training process; and
A participation mode.

Regardless, the server NWDAF 204 is then configured to send a search message to the consumer NFs 206a-206n (lines 266, 268). In accordance with the present disclosure, the following parameters are contained in the search message.
One or more Analytics IDs;
A ML correlation ID or a FL correlation ID; and
A participation mode. The possible participation modes for the consumer NFs 206a-206n are listed above as Mode A-Mode E.

After receiving the search message from the server NWDAF 204, the consumer NFs 206a-206n decide whether or not to participate in the ML model training process announced by the server NWDAF 204. The consumer NF(s) 206a-206n that decide to participate in the training process then send a response to the server NWDAF 204 with response information requesting to participate in the ML model training process (lines 270, 272). As seen in FIG. 9, for example, the consumer NFs 206a-206n may respond by providing the following parameters to the server NWDAF 204.
One or more Analytics IDs;
A ML correlation ID or a FL correlation ID; and
A participation mode (identified above as Mode A-Mode E).

After receiving the response(s) from the consumer NF(s) 206a-206n, the server NWDAF 204 decides whether allow one or more of the consumer NF(s) 206a-206n to participate in the upcoming/ongoing ML model training process (box 274). As above, a server NWDAF 204 configured according to the present embodiments makes that determination based on its own training logic, one or more local policies accessible to the server NWDAF 204, and the information provided in the response information from the consumer NF(s) 206a-206n.

The server NWDAF 204 responses to consumer NF(s) 206a-206n indicating whether it has been selected to participate in the upcoming/ongoing ML model training process (lines 276, 278). According to the present embodiments, the server NWDAF 204 is configured to provide the following information to the consumer NFs 206a-206n.
An indication of whether the consumer NF 206a-206n is or is not allowed to participate in the ML model training process; and
The supported participation mode for the consumer NF 206a-206n to use when participating in the upcoming/ongoing ML model training process.

It should be noted here that the consumer NF(s) receiving a response from the server NWDAF indicating that they are approved for participation in the ML model training process will participate in the ML model training process according to the supported participation mode indicated in the response.

As previously stated, FIG. 10 illustrates some example messaging 280 for a consumer NF 206a-206n (e.g., NWDAF service consumers having respective AnLFs) to announce their ability to participate in the training of an ML model, and for a server NWDAF 204 to select one or more of those consumer NFs 206a-206n to participate in the training of an ML model according to one or more embodiments of the present disclosure.

As seen in FIG. 10, each of the consumer NFs 206a-206n and the server NWDAF 204 first registers its respective profile in a registry, such as an NRF, for example (box 282). As stated above, both the server NWDAF 204 and the consumer NFs 206a-206n are configured to provide new registration elements in addition to the conventional NRF registration elements. Particularly, the server NWDAF 204 is configured to also provide:
Information indicating the capability of the server NWDAF 204 to support the participation of a consumer NF 206a-206n in an ML model training process; and
If available, a supported participation mode.

The consumer NFs 206a-206n are configured to also provide:
Information indicating the capability of the consumer NF 206a-206n to participate in an ML model training process; and
A supported participation mode.

Optionally, one or more consumer NFs 206a-206n can discover a server NWDAF 204 from registry (e.g., the NRF) by invoking the Nnrf_NFDiscovery_Request service operation (box 284). In such cases, the consumer NFs 206a-206n may provide the following parameters in the discovery request in addition those that are conventionally included.
An indication of the server NWDAF's 204 capability to support consumer NFs 206a-206n in ML model training processes; and
A participation mode.

The consumer NF 206a-206n then sends a message to the server NWDAF 204 announcing that it can participate in the ML model training process (lines 286, 288). According to the present disclosure, the following parameters may be included in the announcement message.
One or more Analytics IDs;
A ML correlation ID or a FL correlation ID; and
A participation mode. The possible participation modes for the consumer NFs 206a-206n are listed above as Mode A-Mode E.

After receiving the announcement message from consumer NF 206a-206n, the server NWDAF 204 decides whether to allow one or more of the consumer NFs 206a-206n to participate in the ML model training process (box 290). As described above, the server NWDAF 204 makes this determination based on its own training logic, one or more local policies accessible to the server NWDAF 204, and the information provided in the announcement message from the consumer NF 206a-206n.

The server NWDAF 204 then responds to each of the consumer NF(s) 206a-206n indicating whether it has been selected to participate in the upcoming/ongoing ML model training process (lines 292, 294). According to the present embodiments, the server NWDAF 204 is configured to provide the following information to the consumer NFs 206a-206n.
An indication of whether the consumer NF 206a-206n is or is not allowed to participate in the ML model training process; and
The supported participation mode for the consumer NF 206a-206n to use when participating in the upcoming/ongoing ML model training process.

As was noted above, the consumer NF(s) 206a-206n receiving a response from the server NWDAF 204 indicating that they are approved for participation in the ML model training process will participate in the ML model training process according to the supported participation mode indicated in the response.

Alternatively, the functions illustrated in box 282 through lines 292, 294 of FIG. 10 could be replaced by the functions of box 244 through line 250 of FIG. 8 either directly, or through replacing the single consumer NF 206 in illustrated in FIG. 8 with a plurality of consumer NFs (e.g., consumer NFs 206a-206n, as seen in FIG. 10). Then, in the context of FIG. 10, the embodiment of FIG. 10 can be viewed as a specific situation of the embodiment illustrated in FIG. 8 with multiple consumer NFs 206a-206n.

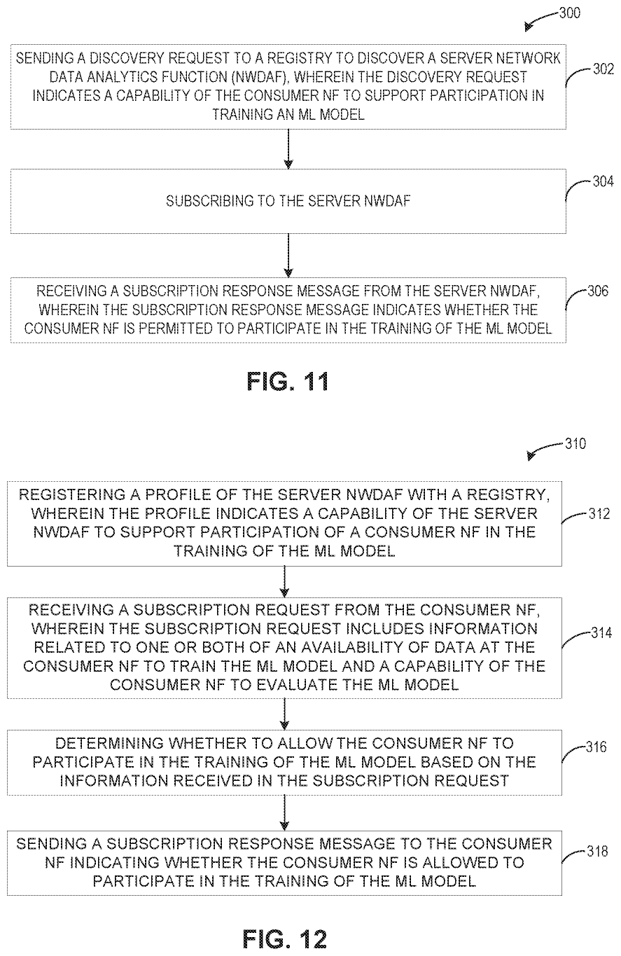

FIG. 11 is a flow diagram illustrating a method 300, implemented by a network node functioning as a consumer NF 206, for determining whether a consumer NF 206 is approved to participate in training a ML model according to one aspect of the present disclosure. As seen in FIG. 11, method 300 calls for the consumer NF 206 to send a discovery request to a registry to discover a server NWDAF 204 (box 302). The discovery request indicates the capability of the consumer NF 206 to support participation in training an ML model. Method 300 then calls for the consumer NF 206 to subscribe to the server NWDAF 204 (box 304). The consumer NF 206 then receives a subscription response message from the server NWDAF 204 (box 306). The subscription response message in this embodiment indicates whether the consumer NF 206 is permitted to participate in the training of the ML model.

In one embodiment, sending the discovery request to the registry to discover the server NWDAF comprises the consumer NF sending an Nnrf_NFDiscovery_Request service message to the registry.

In one embodiment, the discovery request further identifies one or more ML model training participation modes supported by the consumer NF 206.

In one embodiment, the discovery request further indicates one or more of an availability of data for use by the consumer NF 206 in the training of the ML model, a capability of the consumer NF 206 to evaluate the training of the ML model, and one or more ML model training participation modes supported by the consumer NF 206.

In one embodiment, the data for use by the consumer NF 206 in the training of the ML model comprises one or more of actual data used by the ML model, test data used to test the ML model, and validation data used to validate the ML model.

In one embodiment, the indication of the capability of the consumer NF 206 to evaluate the training of the ML model indicates whether the consumer NF 206 is capable of testing or validating an accuracy of the ML model.

In one embodiment, the ML model is one of an initial trained ML model, an intermediate trained ML model, and a final ML model.

In one embodiment, the one or more ML model training participation modes supported by the consumer NF 206 comprises a first participation mode in which the consumer NF 206 participates in evaluating a status of the ML model, a second participation mode in which the consumer NF 206 substantially continuously participates in the training of the ML model to evaluate the ML model, a third participation mode in which the consumer NF 206 periodically participates in the training of the ML model to evaluate the ML model, a fourth participation mode in which the consumer NF 206 is triggered by the server NWDAF 204 to participate in the training of the ML model to evaluate the ML model, and a fifth participation mode in which the consumer NF 206 provides a final evaluation of the ML model.

In one embodiment, in the first participation mode, the consumer NF 206 evaluates the ML model and provides an ML model status to the server NWDAF 204.

In one embodiment, the subscription response message received from the server NWDAF 204 comprises one or both of an indication that the consumer NF 206 is approved to participate in the training of the ML model, and a selected ML model training participation mode for the consumer NF 206 to use in training the ML model. The selected ML model training participation mode is selected by the server NWDAF 204 from the one or more ML model training participation modes included in the discovery request.

FIG. 12 is a flow diagram illustrating a method 310, implemented by a network node functioning as a server NWDAF 204, for determining whether a consumer NF 206 is approved to participate in training a ML model according to one aspect of the present disclosure. As seen in FIG. 12, the server NWDAF 204 first registers a profile of the server NWDAF 204 with a registry (box 312). The profile indicates the capability of the server NWDAF 204 to support participation of a consumer NF 206 in the training of the ML model. The server NWDAF 204 then receives a subscription request from the consumer NF 206 (box 314). In this embodiment, the subscription request includes information related to one or both of an availability of data at the consumer NF 206 to train the ML model and a capability of the consumer NF 206 to evaluate the ML model. The server NWDAF 204 then determines whether to allow the consumer NF 206 to participate in the training of the ML model based on the information received in the subscription request (box 316) before sending a subscription response message to the consumer NF 206 indicating whether the consumer NF 206 is allowed to participate in the training of the ML model (box 318).

In one embodiment, the profile of the server NWDAF 204 further indicates one or more ML model training participation modes supported by the server NWDAF 204 for use in the training of the ML model.

In one embodiment, the subscription request further indicates one or more of an availability of the data for use by the consumer NF 206 in the training of the ML model, a capability of the consumer NF 206 to evaluate the training of the ML model, and one or more ML model training participation modes supported by the consumer NF 206.

In one embodiment, determining whether to allow the consumer NF 206 to participate in the training of the ML model is further based on training logic accessible to the server NWDAF 204 and/or one or more policies of the server NWDAF 204.

In one embodiment, the subscription response message sent to the consumer NF 206 comprises one or both of an indication that the consumer NF 206 is approved to participate in the training of the ML model, and a selected ML model training participation mode for the consumer NF 206 to use in training the ML model. In this embodiment, the selected ML model training participation mode is selected by the server NWDAF 204 from the one or more ML model training participation modes included in the discovery request.

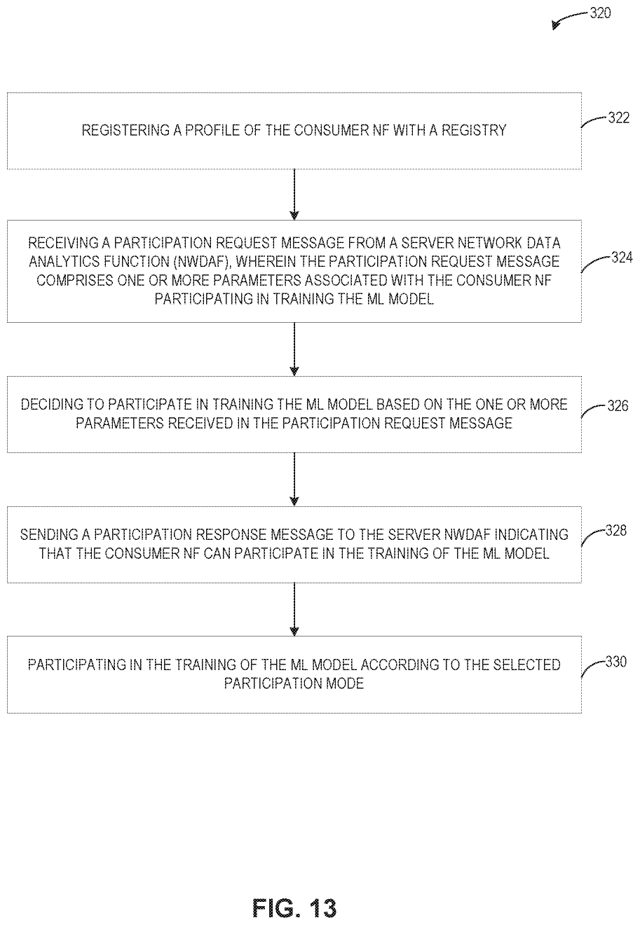

FIG. 13 is a flow diagram illustrating a method 320, implemented by a network node functioning as a consumer NF 206, for selecting a consumer NF 206 to evaluate a ML model prior to training the ML model according to one aspect of the present disclosure. As seen in FIG. 13, method 320 calls for consumer NF 206 to receive a participation request message from a server NWDAF 204 (box 324). In this embodiment, the participation request message comprises one or more parameters associated with the consumer NF 206 participating in training the ML model. Method 320 then calls for the consumer NF 206 to decide to participate in training the ML model based on the one or more parameters received in the participation request message (box 326). The consumer NF 206 then sends a participation response message to the server NWDAF 204 indicating that the consumer NF 206 can participate in the training of the ML model box 328).

In one embodiment, method 320 also calls for the consumer NF 206 to register a profile of the consumer NF 206 with a registry (box 322).

In one embodiment, the profile of the consumer NF 206 comprises information indicating one or both of a capability of the consumer NF 206 to support participating in the training of the ML model, and one or more ML model training participation modes supported by the consumer NF 206.

In one embodiment, the one or more parameters received with the participation request message comprise one or more of an analytics ID, an ML correlation ID or a Federated Learning (FL) correlation ID, and a selected ML model training participation mode for the consumer NF 206 to participate in the training of the ML model.

In one embodiment, the one or more ML model training participation modes supported by the consumer NF 206 comprises a first participation mode in which the consumer NF 206 participates in evaluating a status of the ML model, a second participation mode in which the consumer NF 206 substantially continuously participates in the training of the ML model to evaluate the ML model, a third participation mode in which the consumer NF 206 periodically participates in the training of the ML model to evaluate the ML model, a fourth participation mode in which the consumer NF 206 is triggered by the server NWDAF 204 to participate in the training of the ML model to evaluate the ML model, and a fifth participation mode in which the consumer NF 206 provides a final evaluation of the ML model.

In one embodiment, the participation response message sent to the server NWDAF 204 comprises one or more of the analytics ID, the ML correlation ID or the FL correlation ID, and the selected ML model training participation mode.

In one embodiment, method 320 further comprises the consumer NF 206 to receive a participation confirmation message from the server NWDAF 204 indicating whether the consumer NF 206 is allowed to participate in the training of the MF model.

In one embodiment, the participation confirmation message further indicates the selected participation mode.

In one embodiment, method 320 further comprises the consumer NF 206 participating in the training of the ML model according to the selected participation mode (box 330).

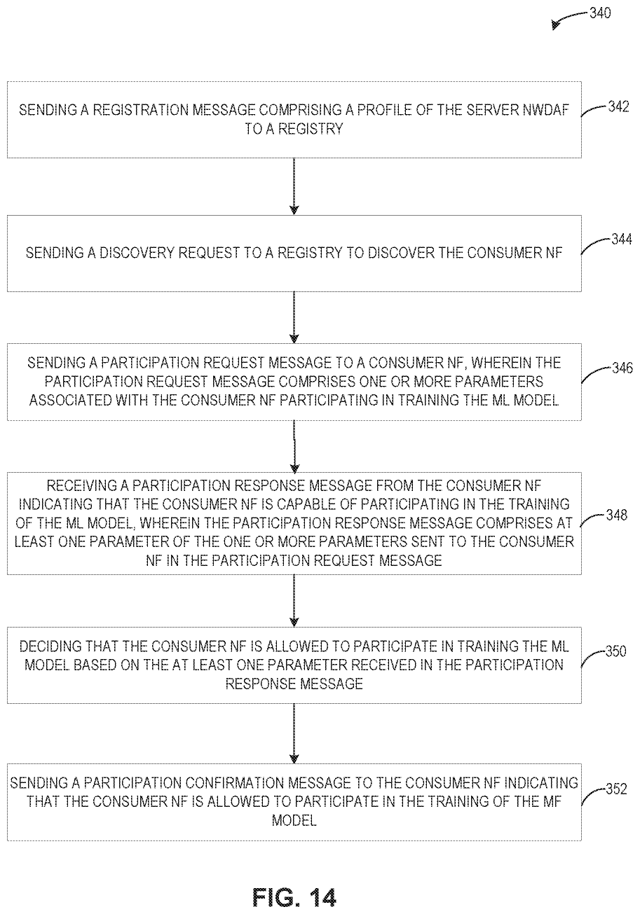

FIG. 14 is a flow diagram illustrating a method 340, implemented by a network node functioning as a server NWDAF 204, for selecting a consumer NF 206 to evaluate a ML model prior to training of the ML model according to one aspect of the present disclosure. As seen in FIG. 14, method 340 begins with the server NWDAF 204 sending a participation request message to a consumer NF 206 (box 346). In his embodiment, the participation request message comprises one or more parameters associated with the consumer NF 204 participating in training the ML model. The server NWDAF 204 then receives a participation response message from the consumer NF 206 indicating that the consumer NF 206 is capable of participating in the training of the ML model (box 348). The participation response message in this embodiment comprises at least one parameter of the one or more parameters sent to the consumer NF 206 in the participation request message. Method 340 then calls for the server NWDAF 204 to decide that the consumer NF 206 is allowed to participate in training the ML model based on the at least one parameter received in the participation response message (box 350), and to send a participation confirmation message to the consumer NF 206 indicating that the consumer NF 206 is allowed to participate in the training of the MF model (box 352).

In one embodiment, method 340 further comprises the server NWDAF 204 sending a registration message comprising a profile of the server NWDAF to a registry (box 342).

In one embodiment, the profile of the server NWDAF 204 comprises information indicating one or both of a capability of the server NWDAF 204 to support participating in the training of the ML model, and one or more ML model training participation modes supported by the server NWDAF 204.

In one embodiment, method 340 further comprises the server NWDAF 204 sending a discovery request to a registry to discover the consumer NF 206 (box 344). In such embodiments, the discovery request indicates one or both of a capability of the consumer NF to support participating in the training of the ML model, and one or more ML model training participation modes supported by the consumer NF 204.

In one embodiment, the one or more parameters included in the participation request message comprise one or more of an analytics ID, an ML correlation ID or a Federated Learning (FL) correlation ID, and an ML model training participation mode that should be supported by the consumer NF 204 to participate in the training of the ML model.

In one embodiment, the at least one parameter in the participation response message comprises one or more of the analytics ID, the ML correlation ID or the FL correlation ID, and the ML model training participation mode.

In one embodiment, deciding that the consumer NF 206 is allowed to participate in training the ML model is further based on training logic at the server NWDAF 204 and/or one or more policies of the server NWDAF 204.

In one embodiment, the participation confirmation message sent to the consumer NF 206 further indicates the ML training participation mode the consumer NF 206 is to use to participate in the training of the ML model.

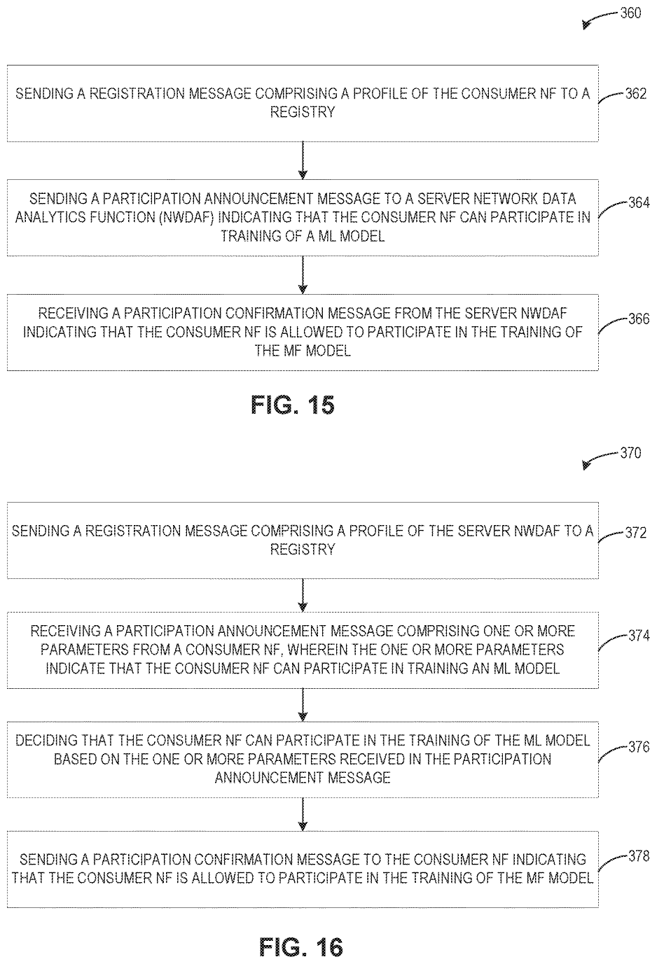

FIG. 15 is a flow diagram illustrating a method 360, implemented by a network node functioning as a consumer NF 206, for selecting a consumer NF 206 to participate in training of a ML model according to one aspect of the present disclosure. As seen in FIG. 15, method 360 comprises the consumer NF 206 sending a participation announcement message to a server NWDAF 204 indicating that the consumer NF 206 can participate in training of a ML model (box 364). The consumer NF 206 then receives a participation confirmation message from the server NWDAF 204 indicating that the consumer NF 206 is allowed to participate in the training of the MF model (box 366).

In one embodiment, method 360 further comprises the consumer NF 206 sending a registration message comprising a profile of the consumer NF to a registry (box 362).

In one embodiment, the profile of the consumer NF comprises information indicating one or both of a capability of the consumer NF to support participating in training the ML model, and one or more ML training participation modes supported by the consumer NF 206.

In one embodiment, the participation announcement message comprises one or more of an analytics ID, an ML correlation ID or a Federated Learning (FL) correlation ID, and the one or more ML model training participation modes supported by the consumer NF 206.

In one embodiment, the participation confirmation message received from the server NWDAF 204 indicates one or both of whether the consumer NF 206 is allowed to participate in the training of the MF model, and a selected ML model training participation mode for the consumer NF 206 to use to participate in the training of the ML model. The selected ML model training participation mode is selected from the one or more ML model training participation modes supported by the consumer NF 206.

In one embodiment, the one or more ML model training participation modes supported by the consumer NF 206 comprise a first participation mode in which the consumer NF 206 participates in evaluating a status of the ML model, a second participation mode in which the consumer NF 206 substantially continuously participates in the training of the ML model to evaluate the ML model, a third participation mode in which the consumer NF 206 periodically participates in the training of the ML model to evaluate the ML model, a fourth participation mode in which the consumer NF 206 is triggered by the server NWDAF 204 to participate in the training of the ML model to evaluate the ML model, and a fifth participation mode in which the consumer NF 206 provides a final evaluation of the ML model.

FIG. 16 is a flow diagram illustrating a method 370 implemented by a network node functioning as a server NWDAF 204, for selecting a consumer NF 206 to participate in training of a ML model according to one aspect of the present disclosure. As seen in FIG. 16, method 370 calls for the server NWDAF 204 to receive a participation announcement message comprising one or more parameters from a consumer NF 206 (box 374). The one or more parameters indicate that the consumer NF 206 can participate in training an ML model. The server NWDAF 204 then decides that the consumer NF 206 can participate in the training of the ML model based on the one or more parameters received in the participation announcement message (box 376). The server NWDAF 204 then sends a participation confirmation message to the consumer NF 206 indicating that the consumer NF 206 is allowed to participate in the training of the MF model (box 378).

In one embodiment, method 370 further comprises the server NWDAF 204 sending a registration message comprising a profile of the server NWDAF 204 to a registry (box 372).

In one embodiment, the profile of the server NWDAF 204 comprises information indicating one or both of a capability of the server NWDAF 204 to support participating in the training of the ML model, and one or more ML training participation modes supported by the server NWDAF 204.

In one embodiment, the one or more parameters received in the participation announcement message comprise one or more of an analytics ID, an ML correlation ID or a Federated Learning (FL) correlation ID, and one or more ML model training participation modes supported by the consumer NF 206.

In one embodiment, deciding that the consumer NF 206 can participate in the training of the ML model is further based on training logic at the server NWDAF 204 and/or one or more policies of the server NWDAF 204.

In any of the present embodiments, the consumer NF 206 comprises an Analytics Logical Function (AnLF) and the server NWDAF 204 comprises a Model Training Logical Function (MTLF).

In any of the present embodiments, the registry comprises a Network Repository Function (NRF).

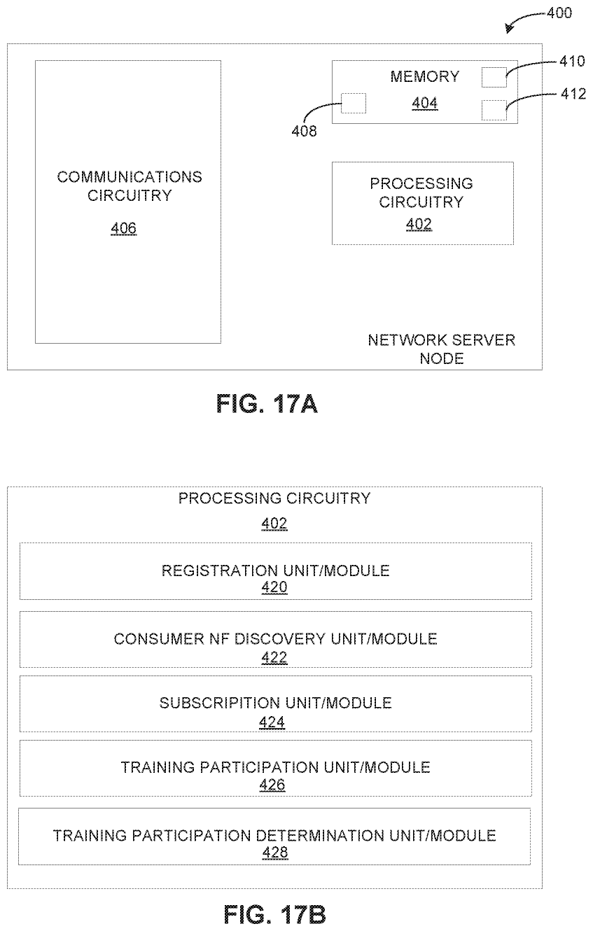

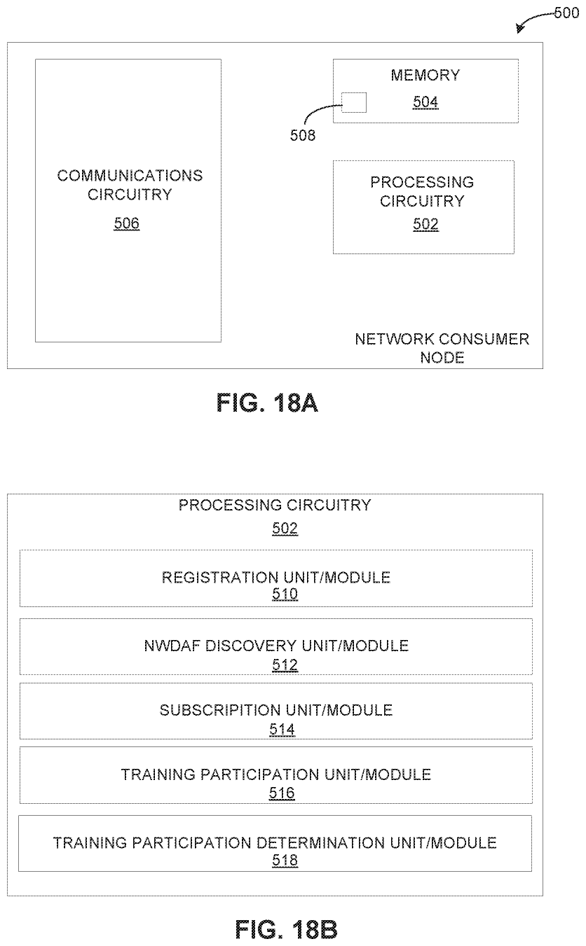

FIG. 17A is a functional block diagram illustrating some components of a network node 400 functioning as a server NWDAF 204. Network node 400, as described above, has MTLF 410 and a set of policies 422 and is configured to select and approve one or more consumer NFs having an AnLF (e.g., consumer NF 500 seen in FIG. 18A) to participate in an upcoming and/or ongoing ML model training process according to one embodiment of the present disclosure. As seen in FIG. 17A, network node 400 comprises processing circuitry 402, memory circuitry 404, and communications circuitry 406. Additionally, as described in more detail below, memory circuitry 404 stores a computer program 408 that, when executed by processing circuitry 402, configures network node 400 to implement the methods herein described.

In more detail, processing circuitry 402 may comprise one or more microprocessors, hardware, firmware, or a combination thereof. In operation, processing circuitry 402 controls the overall operation of network node 400 and processes the data and information according to the present embodiments. Such processing includes, but is not limited to, the network node 400 registering a profile of the network node 400 (e.g., server NWDAF 204) with a registry, wherein the profile indicates a capability of the network node 400 to support participation of a consumer NF in the training of the ML model, receiving a subscription request from the consumer NF, wherein the subscription request includes information related to one or both of an availability of data at the consumer NF to train the ML model and a capability of the consumer NF to evaluate the ML model, determining whether to allow the consumer NF to participate in the training of the ML model based on the information received in the subscription request, and sending a subscription response message to the consumer NF indicating whether the consumer NF is allowed to participate in the training of the ML model.

Additionally, in some embodiments, the processing further includes network node 400 sending a participation request message to a consumer NF, wherein the participation request message comprises one or more parameters associated with the consumer NF participating in training the ML model, receiving a participation response message from the consumer NF indicating that the consumer NF is capable of participating in the training of the ML model, wherein the participation response message comprises at least one parameter of the one or more parameters sent to the consumer NF in the participation request message, deciding that the consumer NF is allowed to participate in training the ML model based on the at least one parameter received in the participation response message, and sending a participation confirmation message to the consumer NF indicating that the consumer NF is allowed to participate in the training of the MF model.

In yet another embodiment, the processing further includes network node 400 receiving a participation announcement message comprising one or more parameters from a consumer NF, wherein the one or more parameters indicate that the consumer NF can participate in training an ML model, deciding that the consumer NF can participate in the training of the ML model based on the one or more parameters received in the participation announcement message, and sending a participation confirmation message to the consumer NF indicating that the consumer NF is allowed to participate in the training of the MF model.

Memory circuitry 404 comprises both volatile and non-volatile memory for storing computer program code and data needed by the processing circuitry 402 for operation. Memory circuitry 404 may comprise any tangible, non-transitory computer-readable storage medium for storing data including electronic, magnetic, optical, electromagnetic, or semiconductor data storage. As stated above, memory circuitry 404 stores a computer program 408 comprising executable instructions that configure the processing circuitry 402 to implement the methods herein described. A computer program 408 in this regard may comprise one or more code modules corresponding to the functions described above.

In general, computer program instructions, such as computer program 408, and configuration information are stored in non-volatile memory, such as a ROM, erasable programmable read only memory (EPROM) or flash memory. Temporary data generated during operation may be stored in a volatile memory, such as a random access memory (RAM). In some embodiments, computer program 408 for configuring the processing circuitry 402 as herein described may be stored in a removable memory, such as a portable compact disc, portable digital video disc, or other removable media. The computer program 408 may also be embodied in a carrier such as an electronic signal, optical signal, radio signal, or computer readable storage medium.

The communications circuitry 406 communicatively connects network node 400 to one or more consumer NFs via one or more communication networks, as is known in the art. In some embodiments, for example, communications circuitry 406 communicatively connects network node 400 to the one or more consumer NFs and/or other nodes and functions (e.g., core network nodes and functions) via a wireline interface. As such, communications circuitry 406 may comprise, for example, an ETHERNET card or other circuitry configured to communicate via the communications network(s).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, such as processing circuitry 402. Such processing circuitry may include one or more microprocessors or microcontrollers, as well as other digital hardware, which may include digital signal processors (DSPs), special-purpose digital logic, and the like. The processing circuitry may be configured to execute program code (e.g., computer program 408) stored in memory 404, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry 402 may be used to cause the respective functional unit/module to perform corresponding functions according one or more embodiments of the present disclosure.

FIG. 17B is a functional block diagram illustrating a computer program product (e.g., computer program 408) that, when executed by the processing circuitry 402 of network node 400, causes network node 400 to perform the methods herein described. Particularly, as seen in FIG. 17B, computer program 408 executed by processing circuitry 402 comprises a registration unit/module 420, a consumer NF discovery unit/module 422, a subscription unit/module 424, a training participation unit/module 426, and a training participation determination unit/module 428.

The registration unit/module 420 comprises computer program code that, when executed by processing circuitry 402, configures network node 400 to register its profile with a registry, such as a NRF, as previously described.

The consumer NF discovery unit/module 422 comprises computer program code that, when executed by processing circuitry 402, configures network node 400 to discover one or more consumer NFs to participate in an ML model training process, as previously described.

The subscription unit/module 424 comprises computer program code that, when executed by processing circuitry 402, configures network node 400 to subscribe/unsubscribe one or more consumer NFs to receive information regarding a ML model training process, and to modify existing subscriptions of the one or more consumer NFs, as previously described.

The training participation unit/module 426 comprises computer program code that, when executed by processing circuitry 402, configures network node 400 to indicate to one or more consumer NFs whether they are allowed to participate in an ML model training process, as previously described.

The training participation determination unit/module 428 comprises computer program code that, when executed by processing circuitry 402, configures network node 400 to determine whether one or more consumer NFs are allowed to participate in an ML model training process, as previously described.

FIG. 18A is a functional block diagram illustrating some components of a network node 500 functioning as a consumer NF 206. Network node 500, as described above, has an AnLF and is configured to participate in an upcoming and/or ongoing ML model training process according to one embodiment of the present disclosure. As seen in FIG. 18A, network node 500 comprises processing circuitry 502, memory circuitry 504, and communications circuitry 506. Additionally, as described in more detail below, memory circuitry 504 stores a computer program 508 that, when executed by processing circuitry 502, configures network node 500 to implement the methods herein described.

In more detail, processing circuitry 502 may comprise one or more microprocessors, hardware, firmware, or a combination thereof. In operation, processing circuitry 502 controls the overall operation of network node 500 and processes the data and information according to the present embodiments. Such processing includes, but is not limited to, sending a discovery request to a registry to discover a server Network Data Analytics Function (NWDAF), wherein the discovery request indicates a capability of the consumer NF to support participation in training an ML model, subscribing to the server NWDAF, and receiving a subscription response message from the server NWDAF, wherein the subscription response message indicates whether the consumer NF is permitted to participate in the training of the ML model.

Additionally, in some embodiments, the processing further includes network node 500 receiving a participation request message from a server Network Data Analytics Function (NWDAF), wherein the participation request message comprises one or more parameters associated with the consumer NF participating in training the ML model, deciding to participate in training the ML model based on the one or more parameters received in the participation request message, and sending a participation response message to the server NWDAF indicating that the consumer NF can participate in the training of the ML model.

In yet another embodiment, the processing further includes network node 500 sending a participation announcement message to a server Network Data Analytics Function (NWDAF) indicating that the consumer NF can participate in training of a ML model, and receiving a participation confirmation message from the server NWDAF indicating that the consumer NF is allowed to participate in the training of the MF model.

Memory circuitry 504 comprises both volatile and non-volatile memory for storing computer program code and data needed by the processing circuitry 500 for operation. Memory circuitry 504 may comprise any tangible, non-transitory computer-readable storage medium for storing data including electronic, magnetic, optical, electromagnetic, or semiconductor data storage. As stated above, memory circuitry 504 stores a computer program 508 comprising executable instructions that configure the processing circuitry 502 to implement the methods herein described. A computer program 508 in this regard may comprise one or more code modules corresponding to the functions described above.

In general, computer program instructions, such as computer program 508, and configuration information are stored in non-volatile memory, such as a ROM, erasable programmable read only memory (EPROM) or flash memory. Temporary data generated during operation may be stored in a volatile memory, such as a random access memory (RAM). In some embodiments, computer program 48 for configuring the processing circuitry 502 as herein described may be stored in a removable memory, such as a portable compact disc, portable digital video disc, or other removable media. The computer program 508 may also be embodied in a carrier such as an electronic signal, optical signal, radio signal, or computer readable storage medium.

The communications circuitry 506 communicatively connects network node 500 to one or more server NWDAFs, such as network node 400, via one or more communication networks, as is known in the art. In some embodiments, for example, communications circuitry 506 communicatively connects network node 500 to the one or more server NWDAFs and/or other nodes and functions (e.g., other consumer NFs, core network nodes, and functions) via a wireline interface. As such, communications circuitry 506 may comprise, for example, an ETHERNET card or other circuitry configured to communicate via the communications network(s).

As above, any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, such as processing circuitry 502. Such processing circuitry 502 may include one or more microprocessors or microcontrollers, as well as other digital hardware, which may include digital signal processors (DSPs), special-purpose digital logic, and the like. The processing circuitry 502 may be configured to execute program code (e.g., computer program 508) stored in memory 504, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, processing circuitry 502 may be used to cause the respective functional unit/module to perform corresponding functions according one or more embodiments of the present disclosure.

To that end, FIG. 18B is a functional block diagram illustrating a computer program product (e.g., computer program 508) that, when executed by the processing circuitry 502 of network node 500, causes network node 500 to perform the methods herein described. Particularly, as seen in FIG. 18B, computer program 508 executed by processing circuitry 502 comprises a registration unit/module 510, a NWDAF discovery unit/module 512, a subscription unit/module 514, a training participation unit/module 516, and a training participation determination unit/module 518.

The registration unit/module 510 comprises computer program code that, when executed by processing circuitry 502, configures network node 500 to register its profile with a registry, such as a NRF, as previously described.

The NWDAF discovery unit/module 512 comprises computer program code that, when executed by processing circuitry 502, configures network node 500 to discover one or more server NWDAFs for participating in an ML model training process, as previously described.

The subscription unit/module 514 comprises computer program code that, when executed by processing circuitry 502, configures network node 500 to subscribe/unsubscribe to one or more server NWDAFs to receive information regarding a ML model training process, and to modify its existing subscriptions, as previously described.

The training participation unit/module 516 comprises computer program code that, when executed by processing circuitry 502, configures network node 500 to indicate to a server NWDAF whether it is capable of participating in an ML model training process, as previously described.

The training participation determination unit/module 518 comprises computer program code that, when executed by processing circuitry 502, configures network node 500 to determine whether it is capable of participating in an ML model training process, as previously described.

Embodiments of the present disclosure further include a carrier containing a computer program, such as computer program 408 and/or computer program 508. This carrier may comprise one of an electronic signal, optical signal, radio signal, or computer readable storage medium.

Embodiments herein also include a computer program product stored on a non-transitory computer readable (storage or recording) medium (e.g., memory 404 and/or memory 504) and comprising instructions that, when executed by the processing circuitry (e.g., processing circuitry 402 and/or processing circuitry 502) of an apparatus, (e.g., network node 400 and/or network node 500) causes the apparatus to perform as described above.

Embodiments further include a computer program product comprising program code portions for performing the steps of any of the embodiments herein when the computer program product is executed by a computing device, such as network node 400 and/or network node 500, for example. This computer program product may be stored on a computer readable recording medium (e.g., memory 404 and/or memory 504).

The present embodiments may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-69. (canceled)

70. A method for determining whether a consumer network function (NF) is approved to participate in training a machine learning (ML) model, the method implemented by a network node functioning as the consumer NF and comprising:
sending a discovery request to a registry to discover a server Network Data Analytics Function (NWDAF), wherein the discovery request indicates a capability of the consumer NF to support participation in training an ML model;
subscribing to the server NWDAF; and
receiving a subscription response message from the server NWDAF, wherein the subscription response message indicates whether the consumer NF is permitted to participate in the training of the ML model.

71. The method of claim 70, wherein sending the discovery request to the registry to discover the server NWDAF comprises the consumer NF sending an Nnrf_NFDiscovery_Request service message to the registry.

72. The method of claim 70, wherein the discovery request further identifies one or more ML model training participation modes supported by the consumer NF.

73. The method of claim 70, wherein the discovery request further indicates one or more of:
an availability of data for use by the consumer NF in the training of the ML model;
a capability of the consumer NF to evaluate the training of the ML model; and
one or more ML model training participation modes supported by the consumer NF.

74. The method of claim 70, wherein the data for use by the consumer NF in the training of the ML model comprises one or more of:
actual data used by the ML model;
test data used to test the ML model; and
validation data used to validate the ML model.

75. The method of claim 74, wherein the indication of the capability of the consumer NF to evaluate the training of the ML model indicates whether the consumer NF is capable of testing or validating an accuracy of the ML model.

76. The method of claim 75, wherein the ML model is one of:
an initial trained ML model;
an intermediate trained ML model; and
a final ML model.

77. The method of claim 73, wherein the one or more ML model training participation modes supported by the consumer NF comprises:
a first participation mode in which the consumer NF participates in evaluating a status of the ML model;
a second participation mode in which the consumer NF substantially continuously participates in the training of the ML model to evaluate the ML model;
a third participation mode in which the consumer NF periodically participates in the training of the ML model to evaluate the ML model;
a fourth participation mode in which the consumer NF is triggered by the server NWDAF to participate in the training of the ML model to evaluate the ML model; and
a fifth participation mode in which the consumer NF provides a final evaluation of the ML model.

78. The method of claim 77, wherein in the first participation mode, the consumer NF evaluates the ML model and provides an ML model status to the server NWDAF.

79. The method of claim 70, wherein the subscription response message received from the server NWDAF comprises one or both of:
an indication that the consumer NF is approved to participate in the training of the ML model; and
a selected ML model training participation mode for the consumer NF to use in training the ML model, wherein the selected ML model training participation mode is selected by the server NWDAF from the one or more ML model training participation modes included in the discovery request.

80. The method of claim 1, wherein the consumer NF comprises an Analytics Logical Function (AnLF) and wherein the server NWDAF comprises a Model Training Logical Function (MTLF).

81. The method of claim 1, wherein the registry comprises a Network Repository Function (NRF).

82. A network node configured to function as a consumer Network Function (NF), the network node comprising:
processing circuitry; and
a memory, the memory containing instructions executable by the processing circuitry whereby the network node is configured to:
send a discovery request to a registry to discover a server Network Data Analytics Function (NWDAF), wherein the discovery request indicates a capability of the consumer NF to support participation in training an ML model;
subscribe to the server NWDAF; and
receive a subscription response message from the server NWDAF, wherein the subscription response message indicates whether the consumer NF is permitted to participate in the training of the ML model.

83. A non-transitory computer readable medium comprising a computer program stored thereon, the computer program comprising instructions which, when executed on processing circuitry of a network node, causes the processing circuitry to:
send a discovery request to a registry to discover a server Network Data Analytics Function (NWDAF), wherein the discovery request indicates a capability of the consumer NF to support participation in training an ML model;
subscribe to the server NWDAF; and
receive a subscription response message from the server NWDAF, wherein the subscription response message indicates whether the consumer NF is permitted to participate in the training of the ML model.
